(19) United States
(12) Patent Application Publication
(10) Pub. No.: US 2025/0211815 A1
(43) Pub. Date: Jun. 26, 2025

(54) METHODS AND APPARATUS TO PRESENT VISUAL INTERFACES

(71) Applicant: DIRECTV, LLC, El Segundo, CA (US)

(72) Inventors: Jordan Matthew Lohrmeyer, Highlands Ranch, CO (US); Brendan Bateson Toupin, Redondo Beach, CA (US); Erin Nelson, Lomita, CA (US); Khoa Tran, Long Beach, CA (US); Camille Chan, Chattanooga, TN (US); Toby Nicholas Marlow, New York City, NY (US); Eric Frommelt, Los Angeles, CA (US); Sumit Gupta, Torrance, CA (US); Jae Young Bae, Rolling Hills Estates, CA (US)

(21) Appl. No.: 18/393,493

(22) Filed: Dec. 21, 2023

(51) Int. Cl. H04N 21/431; H04N 21/433; H04N 21/84

(52) U.S. Cl. CPC H04N 21/4312; H04N 21/433; H04N 21/84

(57) ABSTRACT

Systems, apparatus, articles of manufacture, and methods are disclosed. An example method includes: playing a first media stream in full screen; determining a user has selected a visual interface; after the user has selected the visual interface, presenting, in a first region of the visual interface, a group of tabs relevant to the user; after the user has selected the visual interface, playing, in a second region of the visual interface, the first media stream; determining the user has selected a second tab within the group; after the user has selected of the second tab, playing, in the second region of the visual interface, a second media stream corresponding to the second tab; after the user has selected of the second tab, determining the user has exited the visual interface without performing an additional selection; and after exiting the visual interface, playing the second media stream in full screen.

### FIELD OF THE DISCLOSURE

This disclosure relates generally to media selection, and, more particularly, to methods and apparatus to present visual interfaces.

### BACKGROUND

In recent years, the amount of media available for a user to view has increased. Some industries use a visual interface to present a user with options to select various media for viewing. The visual interface may enable the user to find and begin consuming media in less time than would be required using other media selection techniques.

### BRIEF DESCRIPTION OF THE DRAWINGS

FIG. 1 is a block diagram of an example implementation of an environment that includes an application manager and a client device to facilitate presentation of a visual interface to select media.

FIGS. 2A-2D are an illustrative example of a timeline showing changes to a visual interface that is generated by programmable circuitry executing an application of FIG. 1.

FIG. 3 is a block diagram of an example client device of FIG. 1.

FIG. 4 is a block diagram of an example implementation of the application manager of FIG. 1.

FIG. 5 is a flowchart representative of example machine-readable instructions and/or example operations that may be executed, instantiated, and/or performed by example programmable circuitry to display the visual interface of FIGS. 2A-2D.

FIG. 6 is a flowchart representative of example machine-readable instructions and/or example operations that may be executed, instantiated, and/or performed by the application manager of FIG. 1 to form a list of tabs as discussed in connection with FIG. 5.

FIG. 7 is a flowchart representative of example machine-readable instructions and/or example operations that may be executed, instantiated, and/or performed by the application manager of FIG. 1 to perform bulk authorization as discussed in connection with FIG. 5.

FIG. 8 is a flowchart representative of example machine-readable instructions and/or example operations that may be executed, instantiated, and/or performed by programmable circuitry executing an application of FIG. 1 to display a visual interface as described in connection with FIG. 5.

FIG. 9 is a flowchart representative of example machine-readable instructions and/or example operations that may be executed, instantiated, and/or performed by programmable circuitry executing an application of FIG. 1 to monitor for a change in tab selection as described in connection with FIG. 8.

FIG. 10 is a flowchart representative of example machine-readable instructions and/or example operations that may be executed, instantiated, and/or performed by the application manager of FIG. 1 to provide a carousel of auxiliary media.

FIG. 11 is a block diagram of a processing platform including programmable circuitry and/or processing circuitry structured to execute, instantiate, and/or perform the example machine-readable instructions and/or perform the example operations of FIGS. 5-10 to implement the client devices, the smart device, and/or the application manager of FIGS. 3 and 4.

FIG. 12 is a block diagram of an example implementation of the programmable circuitry and/or processor circuitry of FIG. 11.

FIG. 13 is a block diagram of another example implementation of the programmable circuitry of FIG. 11.

FIG. 14 is a block diagram of a software/firmware/instructions distribution platform (e.g., one or more servers) to distribute software, instructions, and/or firmware (e.g., corresponding to the example machine-readable instructions of FIGS. 5-10) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

The quality of a user's experience when interacting with a visual interface depends on a variety of factors. One factor is the time required for a user to find and select a media for consumption (e.g., listening and/or viewing). If the initial options presented in the visual interface are unappealing to a user, the user may become frustrated looking for alternative viewing options in the visual interface and/or may become disinterested in the continued use of the visual interface.

Another factor affecting user experience is a time delay between when a user makes a media selection on the visual interface and when the user is presented with the selected media. In some examples, this delay is referred to as a lag time or a buffer time. In general, users may become more impatient and/or more frustrated with a visual interface as the length of lag times increase.

Example methods, apparatus, and systems herein enable a visual interface for users to discover and consume media. As described herein, programmable circuitry executing an application causes a display to present a visual interface including a series of tabs containing visual icons, a window that plays broadcasted video of a primary program, and a carousel of recommended auxiliary media. The primary program and the carousel of auxiliary media are selected based on one or more of the subject matter represented in the visual icon of the selected tab, watch history, and user profiles.

Advantageously, user selection of a different tab causes programmable circuitry executing the application to load and play a new primary program that corresponds to the different tab. In some examples, the loading and playing of a new primary program in response to a change in selection is referred to as automatic tuning. Accordingly, the user can exit the visual interface including tabs and the carousel, and watch the new primary program in full screen, without needing to explicitly select the primary program or wait for an additional buffering period.

A user may select a second tab including a second primary program before a first primary program associated with the previously selected first tab has completed loading. In such examples, programmable circuitry executing the application may store media stream portions of the first primary program in a cache to reduce future load times should the user return to the first tab. As such, programmable circuitry executing the application enables users to quickly find and begin watching relevant media, thereby improving user experience relative to other media display techniques.

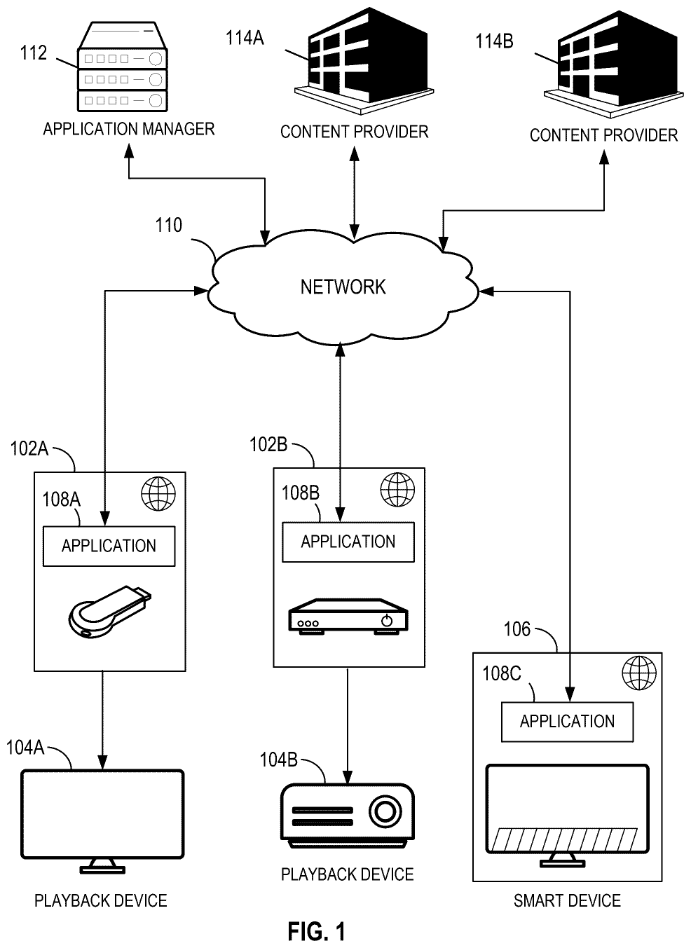

FIG. 1 includes client devices 102A and 102B (collectively referred to as client devices 102), playback devices 104A and 104B (collectively referred to as playback devices 104), a smart device 106, applications 108A, 108B, 108C, a network 110, an application manager 112, and content providers 114A and 114B (collectively referred to as content providers 114).

The client devices 102 are devices that connect to both the network 110 and one of the playback devices 104. For example, in FIG. 1, the client device 102A connects to the playback device 104A and the client device 102B connects to the playback device 104B. The client devices 102 may provide audio and/or visual data to the respective playback devices 104 for display. The client devices 102 may determine what audio/visual data to provide by implementing one or more software applications. In the example of FIG. 1, both client devices 102 provide audio/visual data based on the application 108.

The client devices 102 may include any type of programmable circuitry. Examples of programmable circuitry include but are not limited to programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). A given client device 102A may be implemented as a media player device, a set top box, a cable box, etc.

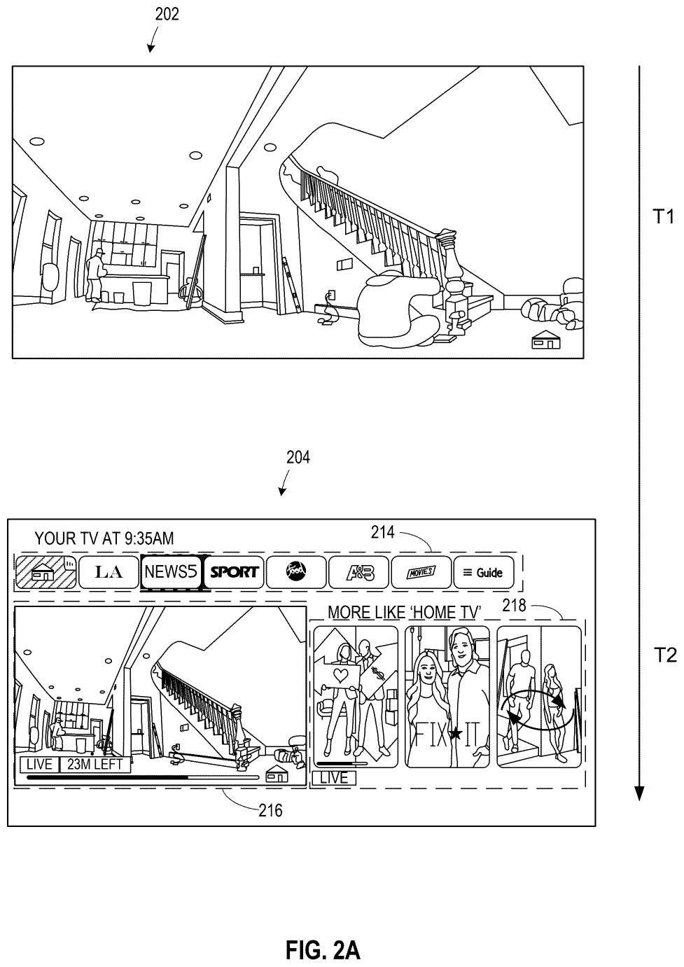

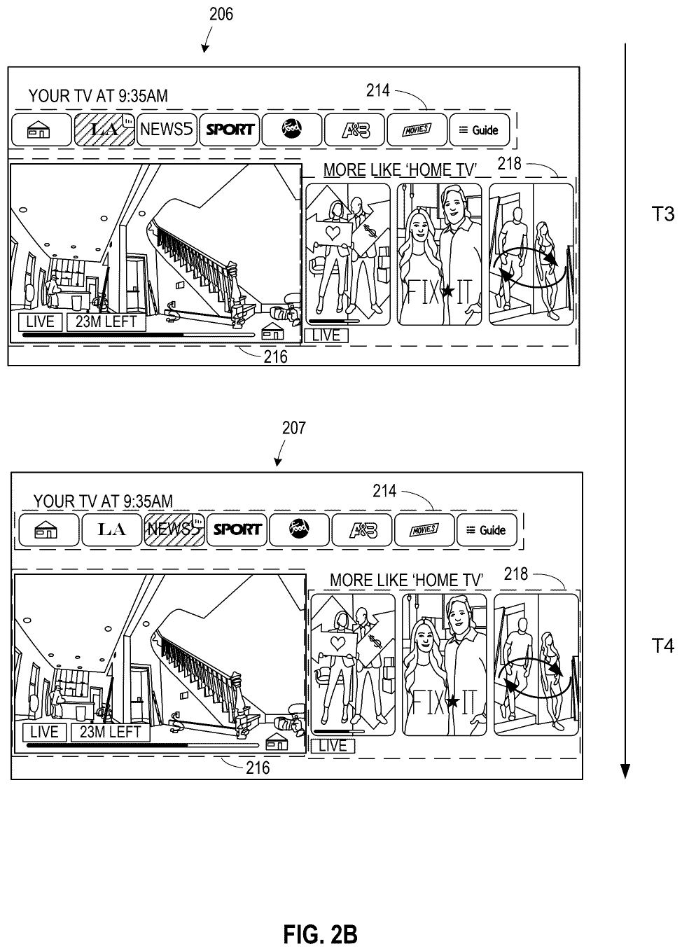

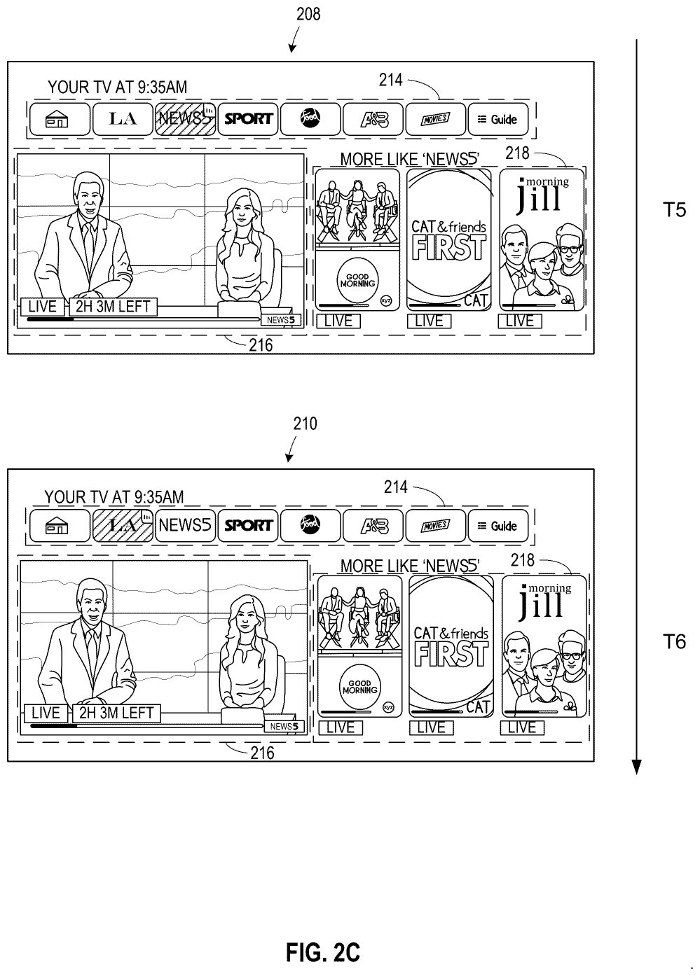

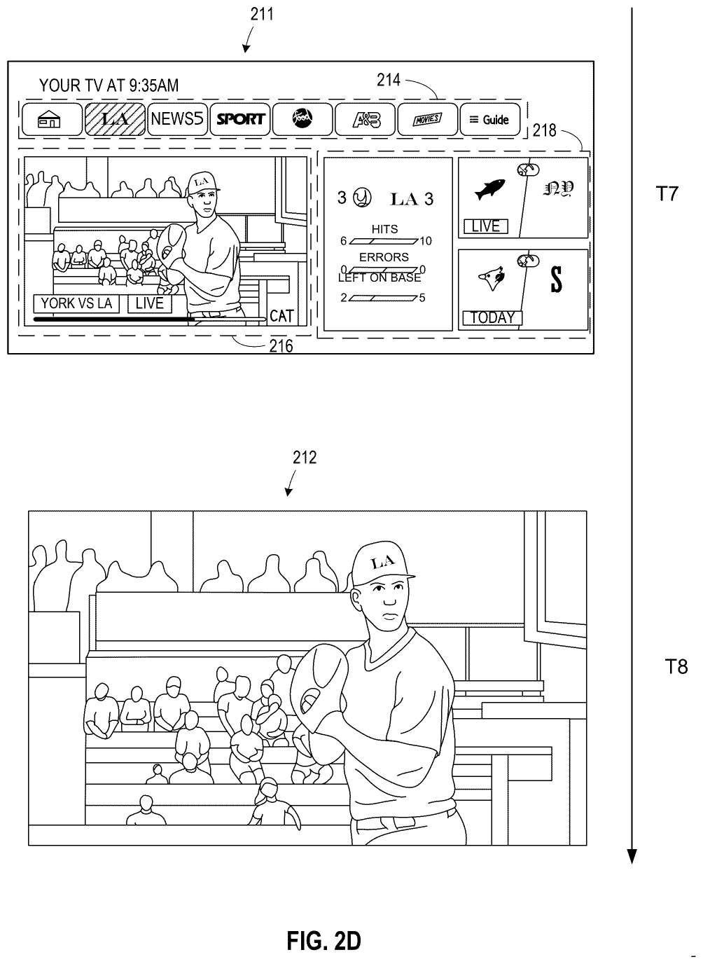

The playback devices 104A, 104B receive audio/visual data from the client devices 102A, 102B respectively. The playback devices 104 present the audio/visual data so it is viewable by a user. The playback devices 104 may be implemented by any device that can display media and communicate with the client devices 102. For example, in FIG. 2, the playback device 104A is a television and the playback device 104B is a projector. The playback devices 104 receive audio/visual data from the client devices 102 using any suitable communication interface. Example communication interfaces for video transmission include but are not limited to Universal Serial Bus-C (USB-C), High-Definition Multimedia Interface (HDMI), Digital Visual Interface (DVI), DisplayPort, Video Graphics Array (VGA), Radio Corporation of America (RCA) cables, etc. In some examples, the playback devices 104 have internal speaker components to present the audio portion of the media. In other examples, the playback devices 104 connect to external speakers to present the audio. The playback devices 104 may include any type of programmable circuitry.

The smart device 106 is a device that includes the functionality of both the client devices 102 and playback devices 104. That is, the smart device 106 connects to the network 110 to obtain audio/visual data based on the application 108C and present the audio/visual data on a display. The smart device 106 may include any type of programmable circuitry. In some examples, the smart device 106 is implemented by a smart tv running the application 108C, a personal computer running the application 108C, an Internet browser running the application 108C on various devices, etc.

The applications 108A, 108B, 108C are machine-readable instructions that may be executed or instantiated (e.g., creating an instance of, bring into being for any length of time, materialize, implement, etc.) by any type of programmable circuitry. In the example of FIG. 1, programmable circuitry within the client devices 102A executes the application 108A, programmable circuitry within the client device 102B executes the application 108B, and programmable circuitry within the smart device 106 executes the application 108C.

Programmable circuitry executing any of the applications 108A, 108B, 108C may obtain media data and present a visual interface in accordance with the teachings of this disclosure. In some examples, the applications 108A, 108B, 108C may be referred to as different versions of a common application. The client devices 102 and/or smart device 106 may execute different versions of a common application for any reason. Such reasons may include but are not limited to differences in operating systems of the client devices 102 and/or the smart device 106, bug fixes, functionality updates, etc. While examples herein refer to the application 108A, the teachings of this disclosure can additionally be applied to the application 108B and/or application 108C.

Programmable circuitry, while executing the application 108A, generates a visual interface and obtains media in accordance with the teachings of this disclosure. In some examples, the visual interface may be referred to as a menu or a guide. The visual interface may additionally or alternatively be referred to as a ten-foot interface because the interface is designed to be displayed on a relatively large screen (e.g., on playback devices 104) that may be viewed from approximately ten feet away, as opposed to being displayed on a device having a relatively small screen (e.g., a mobile phone, a tablet, etc.).

To generate the visual interface, programmable circuitry executing the application 108A may use the network 110 to request media data from the application manager 112 and/or the content providers 114. As used above and herein, media data may refer to video data (e.g., synchronized image and audio data of a movie, television show, etc.) and/or metadata (e.g., actor names, genre information, run-times, scheduling information, etc.). In examples described herein, programmable circuitry executing the application 108A determines which media should be presented in the visual interface and obtains corresponding metadata from the application manager 112. Programmable circuitry executing the application 108A then obtains the corresponding video data from one or more of the content providers 114.

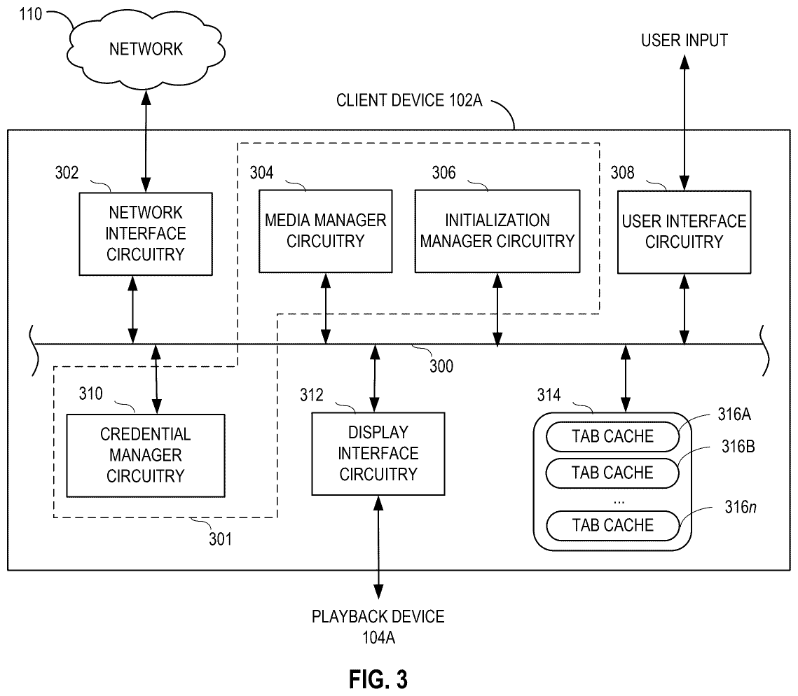

After obtaining media data, programmable circuitry, while executing the application 108A, provides audio/visual data of the visual interface and/or video data for presentation on the playback devices 104 and the smart device 106. The visual interface produced by the programmable circuitry executing the application 108A are discussed further in connection with FIGS. 2A-2D and FIG. 3.

The network 110 of FIG. 1 connects and facilitates communication between one or more of the client devices 102, the smart device 106, the application manager 112, and the content providers 114. In this example, the network 110 is the Internet. However, the network 110 may be implemented using any suitable wired and/or wireless network(s) including, for example, one or more data buses, one or more local area networks (LANs), one or more wireless LANs (WLANs), one or more cellular networks, one or more coaxial cable networks, one or more satellite networks, one or more private networks, one or more public networks, etc. As used above and herein, the term “communicate” including variances (e.g., secure or non-secure communications, compressed or non-compressed communications, etc.) thereof, encompasses direct communication and/or indirect communication through one or more intermediary components and does not require direct physical (e.g., wired) communication and/or constant communication, but rather includes selective communication at periodic or aperiodic intervals, as well as one-time events.

In examples described herein, the application manager 112 is a device that identifies media for presentation on a playback device or smart device. The application manager 112 may also provide metadata (e.g., data that describes the identified media) and organizational data (e.g., data that describes the layout of the visual interface) to programmable circuitry executing the application 108A.

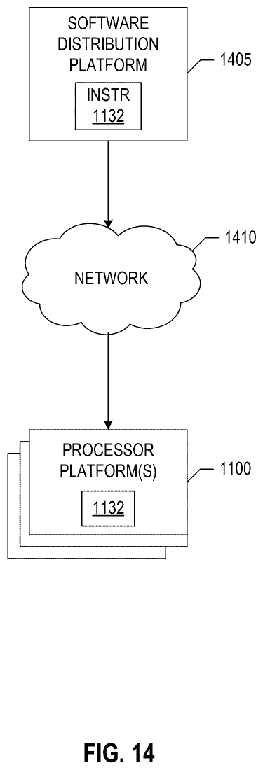

In other examples, the application 108A includes logic that enables programmable circuitry within one of the client devices 102 or the smart device 106 to independently identify media to present and organize the media within the visual interface. In such examples, the application manager 112 is an implementation of the software distribution platform 1405 of FIG. 14 that maintains the application 108A through software updates.

While a client device 102A and corresponding playback device 104A may be implemented in the same location (e.g., a living room, a classroom, an office, etc.), the application manager 112 may be implemented remotely (in a different location) with reference to the other devices illustrated in FIG. 1. In some examples, the application manager 112 may be referred to as a head-end server and/or a back-end server. The application manager 112 may be implemented by any type of programmable circuitry. The application manager 112 is discussed further in connection with FIG. 2.

The content providers 114A and 114B both provide a media stream that may be presented on any of the playback devices 104 or smart device 106. A given content provider 114A may host one or more compute devices (e.g., servers) that receive requests for content and provide a corresponding media stream via the network 110.

In examples described herein, a media stream refers to video data of a linearly broadcasted television channel. In other examples, the media streams may additionally or alternatively refer to video data of other formats (video on demand (VoD), streaming platforms, etc.). The media stream may correspond to any type of content, including news, sports, television shows, movies, etc. The example of FIG. 1 illustrates two content providers 114A and 114B for simplicity. In practice, the application 108A may request media from any number of content providers.

FIGS. 2A-2D are an illustrative example of a timeline showing changes to a user interface that may occur in response to user input. FIGS. 2A-2D includes views 202, 204, 206, 207, 208, 210, 211, and 212. The views 204, 206, and 208 each include regions 214, 216, and 218. FIGS. 2A-2D also include a timeline with timestamps T1 through T6, arranged in chronological order such that actions described in connection with T1 occur before actions described in connection with T2, etc. The amount of time between the timestamps of FIGS. 2A-2D is not uniform.

A given view in FIGS. 2A-2D is an illustrative example of what the playback devices 104 or the smart device 106 display on a screen based on instructions from programmable circuitry executing the application 108A. Collectively, the timeline of FIGS. 2A-2D is an illustrative example of how programmable circuitry within the client device 102A, while executing the application 108A, updates the playback device 104A in response to user inputs and in accordance with the teachings of this disclosure.

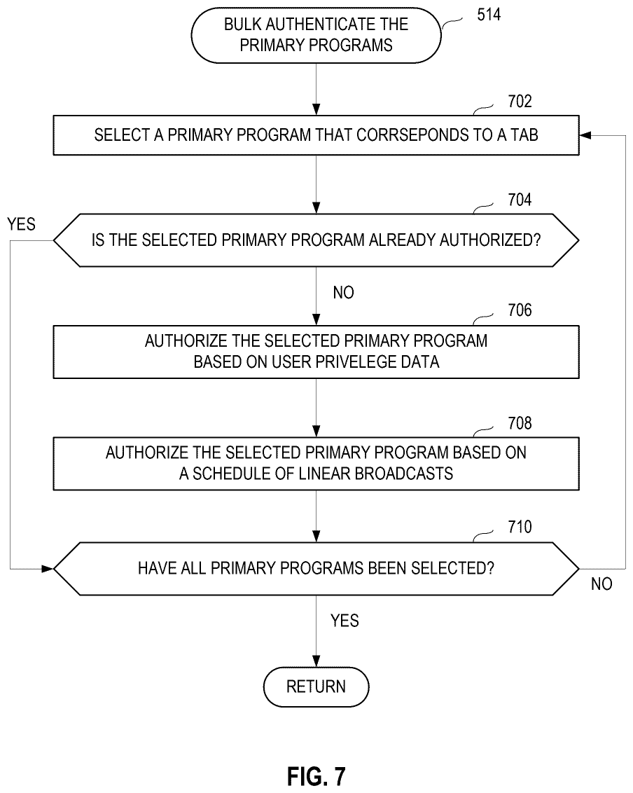

The timeline begins at T1 in FIG. 2A, where the view 202 shows a linearly broadcasted video on display in full screen. In some examples, linearly broadcasted video may be referred to as live media because viewers tuned to a linear broadcast viewers watch pre-scheduled programs in real time. Linearly broadcasted video may additionally or alternatively be referred to as a media stream. The video may correspond to any of the content providers 114 that a user is authorized to receive media from. Authorization of media is discussed further in connection with FIG. 7. In the example of FIG. 2A, the view 202 on the playback device 104A is a program from a home improvement channel.

Between T1 and T2, a user provides an input to the client device 102A select the visual interface. In response, the programmable circuitry, while executing the application 108A, displays the visual interface shown in view 204 at T2.

The visual interface described in examples herein includes multiple regions. In the region 214, programmable circuitry, while executing the application 108A, displays a series of tabs. In some examples, a tab may be referred to as a page or a pin. A given tab in the region 214 includes a visual icon. The visual icon corresponds to media that the user may access from the content providers 114. In the example of FIG. 2A, the icons include logos of the home improvement channel shown in full screen at T1, a sports team, a local news channel, a sports channel, a cooking channel, and movie channels. In other examples, the region 214 may include icons other than channel logos and sports logos, including but not limited to icons describing actors, content genres, etc.

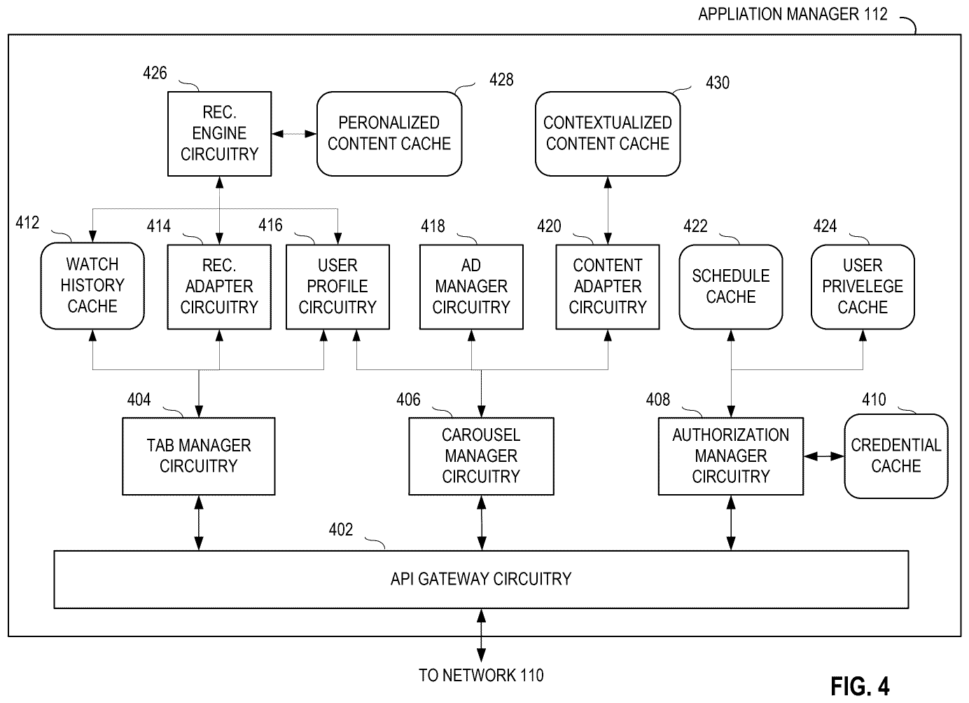

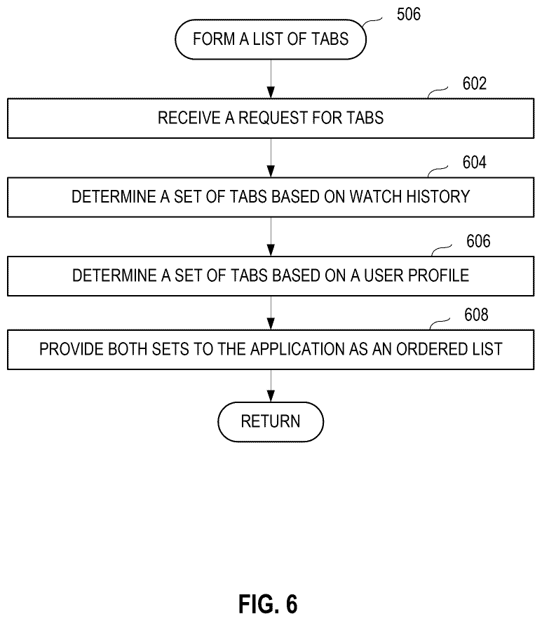

Programmable circuitry, while executing the application 108A, presents the tabs in a specific order within the region 214 based on relevance to the user. In the example of FIG. 2A, the home improvement channel from view 202 is shown on the leftmost tab because the home improvement channel provided the media that was most recently viewed in full screen. The programmable circuitry, while executing the application 108A, also visually indicates one of the tabs within the region 214 to be selected at any point in time. When a user enters the visual interface, programmable circuitry executing the application 108A initially selects the leftmost tab. Accordingly, the home improvement channel tab is selected in the view 204. The order of tabs in the visual interface is discussed further in connection with FIGS. 4 and 6.

In the region 216 of the visual interface, programmable circuitry, while executing the application 108A, plays a linearly broadcasted video. In examples described herein, a linearly broadcasted video actively playing in the region 216 or identified for presentation in the region 216 may be referred to as a primary program. In some examples, the application 108A, the playback devices 104, and/or the smart device 106 may be referred to as “tuned” to the primary program that is presently playing in the region 216. For example, the region 216 contains high resolution video that continuously outputs visual and audio data from a linear broadcast until a user provides a different input (e.g., changes tabs in the region 214, selects a media title from the region 218, powers the device off, etc.). Programmable circuitry executing the application 108A allows users to fully watch media while in the visual interface, thereby improving user experience compared to other interfaces that only provide low-resolution previews of selectable media.

Programmable circuitry, while executing the application 108A, selects a primary program to play in the region 216 based on the selected tab. Accordingly, at T2, the programmable circuitry plays the same program from view 202 in the region 216 of view 204. The selection of a primary program for presentation is discussed further in connection with FIGS. 4 and 6.

In region 218 of the visual interface, programmable circuitry, while executing the application 108A, presents multiple posters (e.g., television posters, movie posters) of media related to the selected tab. In some examples, the region 218 may be described as containing a carousel of media because a user can scroll through the region 218 to view the posters in a circular fashion. The region 218 may additionally or alternatively be described as containing auxiliary media because the programs in region 218 are secondary in nature to, and/or chosen because of, the primary program of region 216. In the view 204, one of the media represented in the region 218 corresponds to a linearly broadcasted video that is currently “live” (e.g., airing in real time as part of a pre-programed schedule), while the other two media in the region 218 correspond to VoD streams. However, while programmable circuitry executing the application 108A plays high resolution video in the region 216 as described above, the programmable circuitry executing the application 108A may use static images to represent the carousel of auxiliary media in the region 218. The selection and organization of auxiliary media within the region 218 is discussed further in connection with FIGS. 4 and 7.

At T3 of FIG. 2B, the user selects the next tab in the ordered sequence of region 214. In response, the user begins to load a new primary program (e.g., a baseball game) based on the selected tab (e.g., the logo of a baseball team) at T3. Advantageously, the view 206 shows that the programmable circuitry, while executing application 108A, continues to play the previous program (e.g., the television show from the home improvement channel) while the next program loads. As a result, programmable circuitry executing the application 108A avoids presenting a blank screen or a loading icon in the region 216, thereby increasing the quality of the user experience.

In this example, the user does not keep the baseball team tab selected long enough after T3 for the baseball game to load (e.g., for the client device 102A to obtain enough media data to play the baseball game in the region 216). Rather, at T4, the user continues to scroll by selecting the next tab in the ordered sequence of region 214. Like before, the view 207 shows that programmable circuitry, while executing the application 108A, continues to play the currently loaded program (e.g., the television show from the home improvement program) while a primary program that corresponds to the selected tab (e.g., a morning news program) is loading.

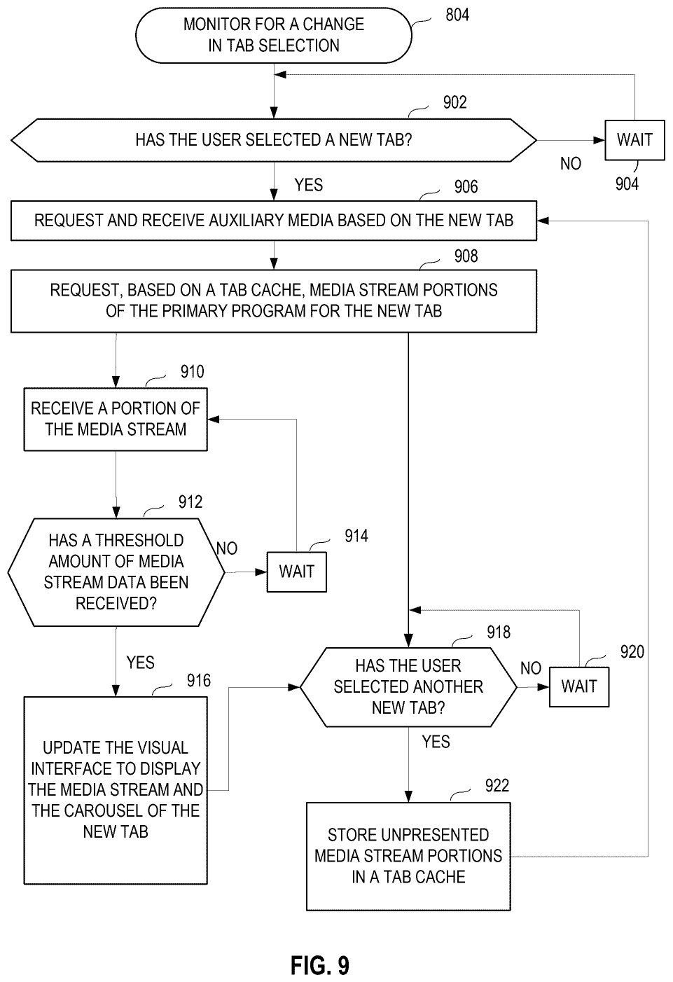

Advantageously, programmable circuitry executing the application 108A does not disregard media data that was obtained while loading the baseball game between T3 and T4. Rather, programmable circuitry, while executing the application 108A, saves some or all of the media data in case the user reselects the baseball team tab in the future. The storage of data from partially loaded primary programs is discussed further in connection with FIGS. 3 and 9.

In this example, the user does keep the local news channel tab selected long enough after T4 to load the corresponding primary program. Accordingly, at T5 in FIG. 2C, the view 208 shows that programmable circuitry executing the application 108A plays the new primary program (e.g., the morning news program) in the region 216. Programmable circuitry executing the application 108A also updates the region 218 at T5 with new auxiliary media based on the selection of the local news channel tab and the presentation of the morning news program.

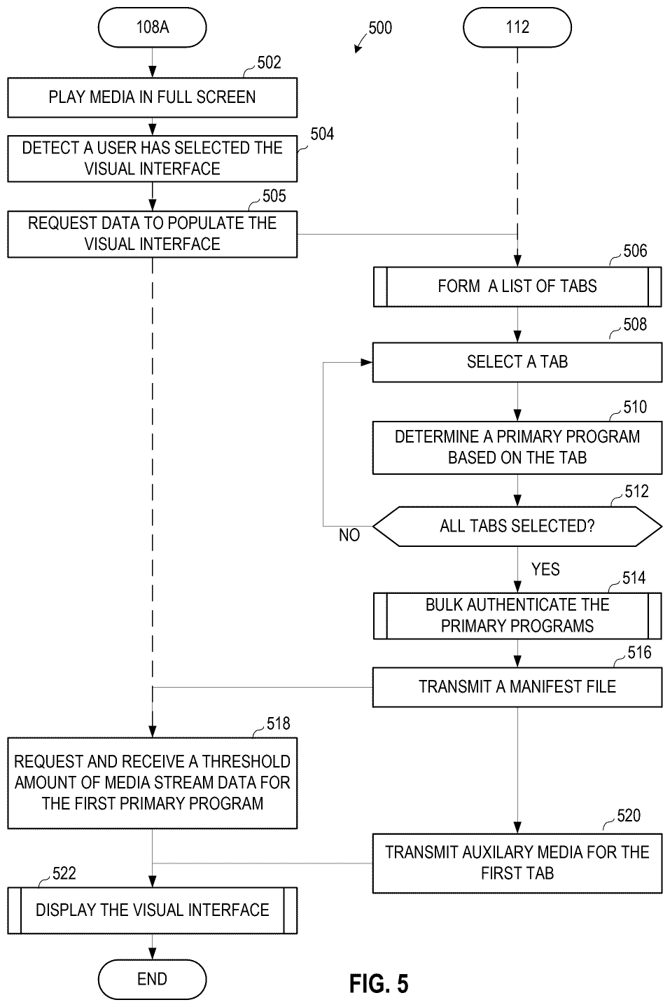

At T6 of this example, the user selects the preceding tab (e.g., the baseball team) in the ordered sequence of the region 214. Like the views 206 and 207, the view 210 shows that programmable circuitry executing the application 108A continues to play the currently loaded program (e.g., the morning news program) while a primary program that corresponds to the selected tab (e.g., the baseball game) is loading. However, at T6, programmable circuitry executing the application 108A requests media data corresponding to the baseball game based on media data that is already present (e.g., from the initial loading of the baseball game between T3 and T4). Requests for media data corresponding to a primary program are discussed further in connection with FIG. 5.

In this example, the user does keep the local news tab selected long enough after T6 to load the corresponding primary program. At T7 in FIG. 2D, the view 211 shows that programmable circuitry executing the application 108A plays the baseball game in the region 216. The view 211 also shows that graphical elements besides television and movie posters may be displayed in the region 218. In the example of FIG. 2D, programmable circuitry executing the application 108A presents the current score and counting statistics of the baseball game shown in the region 216, a poster for a different baseball game that is currently airing on a different linear broadcast, and a poster for another different baseball game that is scheduled to air later. More generally, programmable circuitry executing the application 108A may use the region 218 to present any sort of auxiliary media, metadata, and/or advertisements based on the primary program playing in region 216.

Advantageously, programmable circuitry executing the application 108A may use already loaded media data to reduce the amount of time required to complete a subsequent load of a primary program. For example, the time between T6 and T7 is shorter than the time between T3 and T(3+t). Here, T(3+t) represents the time at which the client device 102A would have loaded the baseball game enough for presentation in the region 216 had the user decided not to select a different tab at T4.

Between T7 and T8, the user provides an input to the client devices 102A to exit the visual interface. When exiting the visual interface, programmable circuitry executing the application 108A resizes the primary program playing in region 216 to instead play in full screen. At T8, the view 212 shows that programmable circuitry executing the application 108A plays the baseball game in full screen. Advantageously, because programmable circuitry executing the application 108A loads programs in response to changes in tab selection, the connected display is already tuned to the baseball game at T7. Accordingly, programmable circuitry executing the application 108A may present the baseball game at T8 as soon as a user input to exit the visual interface is received, without needing to wait for additional buffering. Furthermore, programmable circuitry executing the application 108A does not require the user to explicitly select the primary program in the region 216 in order to view the primary program in full screen. Rather, the user can view the primary program in full screen by providing any input to the client device 102A that would be interpreted as an instruction to exit the visual interface. User inputs are discussed further in connection with FIG. 3.

FIG. 3 is a block diagram of an example implementation of the client device 102A that implements the application 108A of FIG. 1. In some examples, a different device (e.g., the client device 102B or the smart device 106 of FIG. 1, etc.) may include one or more components of FIG. 3.

The client device 102A of FIG. 3 may be instantiated by programmable circuitry such as a Central Processor Unit (CPU) executing first instructions (e.g., instructions that include the application 108A). Additionally or alternatively, the client device 102A of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

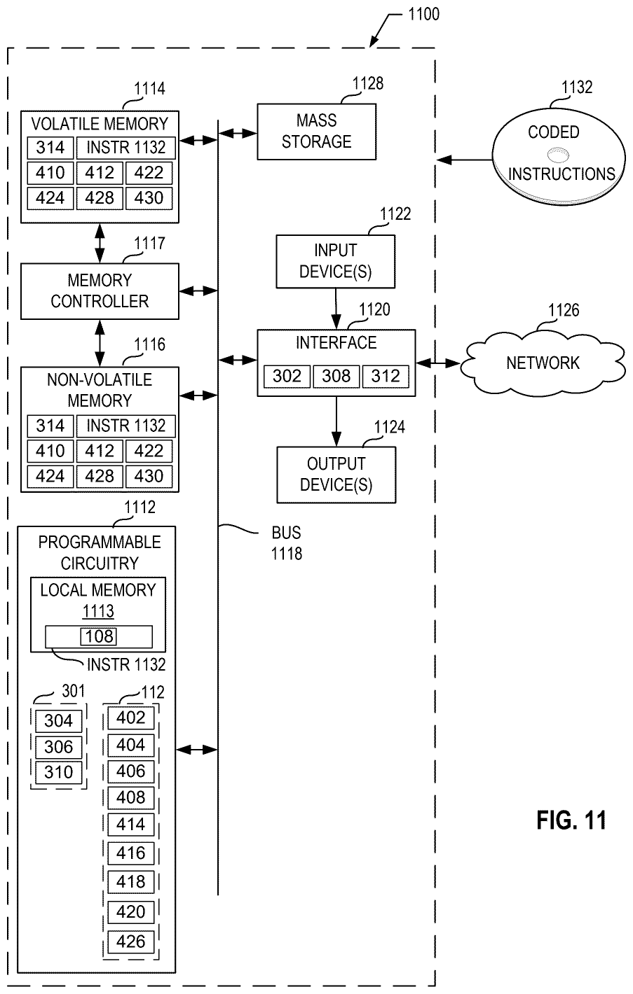

FIG. 3 includes the client device 102A, the network 110, and the playback device 104A. The client device 102A includes a bus 300, programmable circuitry 301, network interface circuitry 302, user interface circuitry 308, display interface circuitry 312, and memory 314. The memory 314 includes tab caches 316A, 316B, . . . , 316n (collectively referred to as tab caches 316). In the example of FIG. 3, programmable circuitry 301 executes the application 108A and thereby instantiates the media manager circuitry 304, initialization manager circuitry 306, and the credential manager circuitry 310. The example programmable circuitry 301 is discussed further in connection with FIG. 11.

The bus 300 refers to one or more physical connections (e.g., an interconnect, copper trace, etc.) that enables communication between the network interface circuitry 302, the media manager circuitry 304, the initialization manager circuitry 306, the user interface circuitry 308, the credential manager circuitry 310, the display interface circuitry 312, and memory 314. The bus 300 may be implemented using one or more communication systems that meet pre-determined threshold power and latency requirements.

The network interface circuitry 302 enables the exchange of data between other components of the client device 102A and external devices (e.g., the application manager 112, the content providers 114, etc.) via the network 110. Programmable circuitry 301 executing the application 108A may cause the network interface circuitry 302 to transmit and/or receive any type of data, including but not limited to application programming interface (API) requests, API responses, media data, etc. The network interface circuitry 302 may include transceivers, antennas, and/or other hardware components required to send and receive Internet data. The network interface circuitry 302 may implement a wired or wireless connection to the network 110. In some examples, some or all of the network interface circuitry 302 is instantiated by programmable circuitry executing network interface instructions and/or configured to perform operations such as those represented by the flowchart(s) of FIGS. 5-10.

When running the application 108A, the programmable circuitry 301 instantiates the media manager circuitry 304 to form API requests for media. The client device 102A transmits the API requests over the network 110 via the network interface circuitry 302. The media requests may refer to a request for media metadata and/or a request for audio/visual data (e.g., a media stream). In the example of FIGS. 2A-2D, the programmable circuitry 301 instantiates the media manager circuitry 304 to generate requests for media at times including but not limited to: when the user first enters the visual interface between T1 and T2, when the user selects a different tab at T3, T4, and T6, etc.

The example media manager circuitry 304 causes the network interface circuitry 302 to transmit API requests to the application manager 112 when determining which media to present and when obtaining metadata. The media manager circuitry 304 also causes the network interface circuitry 302 to transmit API requests to one or more content providers 114 when requesting the media stream itself (e.g., video data). In other examples, the media manager circuitry 304 may request different types of data from different sources. In some examples, the media manager circuitry 304 is instantiated by programmable circuitry 301 executing the application 108A, by other hardware, and/or by a different hardware/software combination. In some examples, the media manager circuitry 304 may perform one or more operations represented by the flowchart(s) of FIGS. 5-10.

When running the application 108A, programmable circuitry within the client device 102A instantiates the initialization manager circuitry 306 to initiate the presentation of media within the visual interface. For example, the initialization manager circuitry 306 may coordinate operations between the media manager circuitry 304, the credential manager circuitry 310, and the display interface circuitry 312 to reduce the lag time between a user selecting a tab in region 214 of the visual interface and the presentation of a corresponding primary program in region 216 of the visual interface. The initialization manager circuitry 306 may be instantiated by programmable circuitry 301 executing the application 108A, by other hardware, and/or by a different hardware/software combination. In some examples, the initialization manager circuitry 306 may perform one or more operations such as those represented by the flowchart(s) of FIGS. 5-10.

The user interface circuitry 308 obtains inputs from a user (e.g., a person or viewing media on the playback device 104A) and interprets the inputs to form instructions for other components of the client device 102. For example, the user interface circuitry 308 may receive an “enter” button press from a remote. The user interface circuitry 308 then performs operations (which may include executing machine-readable instructions from the application 108A) to determine whether the button press should be interpreted as a command to enter the visual interface, exit the visual interface, etc. The user interface circuitry 308 may include receivers, antennas, and/or other hardware components required to obtain user inputs. The user interface circuitry 308 may use any suitable form of user input, including but not limited to button presses from a remote or software application, voice commands, etc. In some examples, the user interface circuitry 308 obtains user inputs via the network interface circuitry 302. In some examples, some or all of the user interface circuitry 308 is instantiated by programmable circuitry executing user interface instructions and/or configured to perform operations such as those represented by the flowchart(s) of FIGS. 5-10.

When running the application 108A, programmable circuitry 301 within the client device 102A instantiates the credential manager circuitry 310 to manage credential data that may be provided in conjunction with an API request for media. As used herein, credential data may refer to any data that could be used to determine whether a user is authorized to view a particular piece of media. Credential data may include but is not limited to cryptographic keys, location data, subscription data, user profiles, parental control settings, etc. The programmable circuitry 301 instantiates the credential manager circuitry 310 to read existing credential data from the memory 314 (e.g., to provide the media manager circuitry 304 with one or more parameters to be transmitted as part of or in conjunction with an API request for media) and to write updated credential data to the memory 314 (e.g., a user profile is added or removed, a location of the client device 102A changes, an encryption algorithm requires cryptographic keys to change periodically, etc.). The credential manager circuitry 310 may be instantiated by programmable circuitry 301 executing the application 108A, by other hardware, and/or by a different hardware/software combination. In some examples, the credential manager circuitry 310 may perform one or more operations such as those represented by the flowchart(s) of FIGS. 5-10. In some examples, credential data may be additionally or alternatively referred to as authorization data.

The display interface circuitry 312 provides audio and/or visual data to be presented on the playback device 104A. The audio/visual data may refer to media playing in full screen, media playing in region 216 of the visual interface, one or more static components of the visual interface, etc. The display interface circuitry 312 may provide audio/visual data to the playback device 104A through any suitable communication interface (e.g., USB-C, HDMI, DVI, DisplayPort, VGA, RCA, etc.) The display interface circuitry 312 may include transceivers, pins ports, and/or other hardware components required to send audio and/or visual data. In some examples, some or all of the display interface circuitry 312 is instantiated by programmable circuitry executing display interface instructions and/or configured to perform operations such as those represented by the flowchart(s) of FIG. 5-10.

In the example of FIG. 3, the display interface circuitry 312 of the client device 102A connects to an external playback device 104A. In examples including the smart device 106, the display interface circuitry 312 may operate as described above but connect to internal display hardware rather than the playback device 104A.

The memory 314 stores data used by other components of the client device 102A to perform operations. For example, the memory 314 may store any or all of the credential data described above. The memory 314 additionally stores media stream portions in the tab caches 316. A given tab cache 316A refers to one or more addresses in memory used for storing data from a partially loaded primary program. For example, in FIG. 2B, the tab cache 316A may store one or more media stream portions of the baseball game that were loaded between T3 and T4. In some examples, the memory 314 includes one tab cache per content provider accessible by the client device 102A. More generally, the memory 314 can include n tab caches, where n is any positive integer. In some examples, a given tab cache 316A may be reserved for storing data from a partially loaded primary program.

The memory 314 may be implemented as any type of memory. For example, the memory 314 may be a volatile memory or a non-volatile memory. The volatile memory may be implemented by Synchronous Dynamic Random Access Memory (SDRAM), Dynamic Random Access Memory (DRAM), and/or any other type of RAM device. The non-volatile memory may be implemented by flash memory and/or any other desired type of memory device.

The loading of a primary program may vary based on any number of factors. Examples of factors that may influence loading times of a primary program include but are not limited to the strength of the connection between the client device 102A and the network 110 of FIG. 1, the type of resources that implement the client device 102A, the application manager 112, the content provider 114, the transmission delay between components in FIG. 1, etc. Advantageously, when loading a primary program, programmable circuitry 301 executing the application 108A causes the initialization manager circuitry 306 to performs operations that minimize the number of requests sent by the client device 102A and the number of responses received by the client device 102A. By minimizing external communications, the initialization manager circuitry 306 reduces the risk that an external device introduces delay and improves the quality of a user experience.

FIG. 4 is a block diagram of an example implementation of the application manager 112 of FIG. 1 to provide media data. The application manager 112 of FIG. 4 may be instantiated by programmable circuitry such as a Central Processor Unit (CPU) executing first instructions. Additionally or alternatively, the application manager 112 of FIG. 4 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers. The application manager 112 includes API gateway circuitry 402, tab personalization circuitry 404, carousel manager circuitry 406, authorization manager circuitry 408, a credential cache 410, a watch history cache 412, recommendation adapter circuitry 414, user profile circuitry 416, advertisement manager circuitry 418, content adapter circuitry 420, a schedule cache 422, a user privilege cache 424, recommendation engine circuitry 426, a personalized content cache 428 and a contextualized content cache 430.

The API gateway circuitry 402 receives API requests from one or more client devices 102 and/or the smart device 106 via the network 110. The API gateway circuitry 402 then interprets the API request and provides corresponding instructions to one or more of the tab manager circuitry 404, the carousel manager circuitry 406, and the authorization manager circuitry 408. For example, API requests may cause the API gateway circuitry 402 to instruct: a) the tab manager circuitry 404 to select visual icons and determine tab order for region 214 of the visual interface, b) the carousel manager circuitry 406 to select auxiliary media for the carousel in region 218 of the visual interface, and/or c) the authorization manager circuitry 408 to confirm a user is authorized to view the primary programs that correspond to the selected tabs.

The API gateway circuitry 402 also packages information received from the foregoing circuits into one or more API responses that are interpretable using machine-readable instructions within the application 108A. The format of API requests and API responses used in examples herein may vary based on factors including but not limited to the type of information exchanged in the API call, the amount of data exchanged in the API call, a choice in programming language, etc. In some examples, the API gateway circuitry 402 is instantiated by programmable circuitry executing API gateway instructions and/or configured to perform operations such as those represented by the flowchart(s) of FIGS. 5-10.

The tab manager circuitry 404 manages region 214 of the visual interface based on instructions from the API gateway circuitry 402. Managing the region 214 may include selecting visual icons to go on tabs and determining an ordered sequence of the tabs. In some examples, the tab manager circuitry 404 additionally selects primary programs that correspond to determined tabs. In some examples, the tab manager circuitry 404 is instantiated by programmable circuitry executing tab management instructions and/or configured to perform operations such as those represented by the flowchart(s) of FIGS. 5-10.

The tab manager circuitry 404 uses the watch history cache 412, the recommendation adapter circuitry 414, and/or the user profile circuitry 416 to determine tab selection and tab order. In examples described herein, the watch history cache 412 refers to an amount of memory that records which media streams were recently viewed in full screen on a given playback device 104A. Accordingly, at T8 of FIGS. 2A-2D, the watch history cache 412 describes the baseball game as the current program and describes the program from the home improvement channel as the last watched program. In other examples, the watch history cache 412 additionally refers to primary programs that were played within the region 216 of the visual interface. In such examples, at T8 of FIGS. 2A-2D, the watch history cache 412 describes the baseball game as the current program, the local news as the last watched program, and the program from the home improvement channel as the third most recent program.

The tab manager circuitry 404 may reserve one or more tabs to represent content providers 114 identified by media streams in the watch history cache 412. For example in FIGS. 2A-2D, programmable circuitry 301 executing the application 108A determines three of seven tabs based on watch history such that the content provider of the most recent program is the first tab from the left, the content provider of the second-most recent program is the second tab from the left, etc. In other examples, the tab manager circuitry 404 determines a different number of tabs and/or a different order of tabs based on watch history. In examples of FIGS. 1-14, the application manager 112 updates the watch history cache 412 based on API calls from the client device 102A that describe what primary program is currently playing. In examples where the client device 102A performs local operations to identify media for presentation in the visual interface, the watch history cache 412 may refer to a portion of the memory 314 of FIG. 3.

The recommendation engine circuitry 426 generates recommended media based on user profile data. As used herein, a user profile may refer to any data that characterizes a user and/or data that may be indicative of the user's viewing preferences. User profile data may include but is not limited to age, gender, location, genres and/or specific pieces of media that were favorited by a user, etc. User profile data may be provided by the client device 102A and managed in the application manager 112 by the user profile circuitry 416. Similarly, in some examples, the user profile circuitry 416 is instantiated by programmable circuitry executing user profile instructions and/or configured to perform operations such as those represented by the flowchart(s) of FIG. 5-10.

The recommendation engine circuitry 426 also generates recommended media based on the contents of the personalized content cache 428. The personalized content cache 428 refers to an amount of memory, managed by the recommendation engine circuitry 426, that stores lists of content determined to be relevant to individual users. For example, the personalized content cache 428 may include a first content list including first media relevant to a first user from the user profile circuitry 416, a second content list including second media relevant to a second user from the user profile circuitry 416, etc. The recommendation engine circuitry 426 adds, removes, and/or generally updates the personalized content cache based on one or more of: the watch history cache 412, the user profile circuitry 416, and media identified from third party recommendation platforms. The personalized content cache 428 may be implemented by any type of volatile or non-volatile memory.

The recommendation adapter circuitry 414 receives the media recommendations from the recommendation engine circuitry 426. The recommendation adapter circuitry 414 then determines whether to adapt (e.g., adjust) the media recommendations before the recommendations are used by the tab management circuitry 404 to determine a tab and/or a primary program. The recommendation adapter circuitry 414 may adjust recommendations based on instructions to prioritize (e.g., upsell) particular pieces of media. Prioritization of media may occur for any reason, including but not limited to the promotion of new media that has not yet had an opportunity for exposure, media from advertisers, video on demand (TVOD) media, etc. In some examples, the recommendation adapter circuitry 414 is instantiated by programmable circuitry executing recommendation adapter instructions and/or configured to perform operations such as those represented by the flowchart(s) of FIG. 5-10

The tab manager circuitry 404 may use the recommendation adapter circuitry 414 to both identify which tabs to display and to select the order of tabs. In the example of FIGS. 2A-2D, the remaining four tabs that do not correspond to watch history are ordered such that the tabs on the left are stronger recommendations (e.g., more likely for a user to be interested in the media) and tabs on the right are weaker recommendations (e.g., less likely for a user to be interested in the media).

After identifying content providers to represent on the tabs, the tab manager circuitry 404 selects one primary program per tab on the visual interface. In examples described herein, the tab manager circuitry 404 selects a primary program from a linear broadcast as described above. However, a given tab may correspond to multiple linear broadcasts. For example, a tab with a logo of a sports network may include a main channel, a secondary channel, a channel specifically for classic games, a channel specifically for college games, a channel specifically for sports news, variations in which one or more of the foregoing channels are broadcasted in different languages, etc. In such examples, the tab manager circuitry 404 selects one primary program from one of the multiple broadcasts to play in the region 216. The tab manager circuitry 404 makes the selection based on the watch history cache 412, the recommendation adapter circuitry 414, and the user profile circuitry 416 as discussed above.

The carousel manager circuitry 406 select auxiliary media to present in region 218 (e.g., the carousel) of the visual interface. The carousel manager circuitry 406 determines what auxiliary information to present in the region based on one or more of the user profile discussed above, the advertisement manager circuitry 418, and the content adapter circuitry 420. In some examples, the carousel manager circuitry 406 is instantiated by programmable circuitry executing carousel manager instructions and/or configured to perform operations such as those represented by the flowchart(s) of FIG. 5-10.

The advertisement manager circuitry 418 presents advertisements for display in the region 218. In some examples, the advertisement manager circuitry 418 instructs the carousel manager circuitry 406 to include a particular program in the carousel and/or for a media poster to have a favorable location in the carousel. The advertisement manager circuitry 418 may provide such instructions in response to an advertiser paying to have a particular program prioritized over other auxiliary media. In other examples, the advertisement manager circuitry 418 instructs the carousel manager circuitry 406 to dedicate an amount of space in the region 218 for a non-selectable advertisement (e.g., an infographic).

The advertisement manager circuitry 418 may cause the inclusion of advertisements in the visual interface carousel based on a description of the primary program and/or whether the user is authorized to view the advertised media. In some examples, the advertisement manager circuitry 418 is instantiated by programmable circuitry executing advertisement manager instructions and/or configured to perform operations such as those represented by the flowchart(s) of FIG. 5-10.

The content adapter circuitry 420 recommends auxiliary media to be included in the visual interface carousel. The content adapter circuitry 420 may identify media from any source, including but not limited to media that is currently playing on a linear broadcast stream, media from streaming platforms that users are subscribed to, etc. In examples, the content adapter circuitry 420 is instantiated by programmable circuitry executing content adapter instructions and/or configured to perform operations such as those represented by the flowchart(s) of FIG. 5-10.

The content adapter circuitry 420 also forms the recommendations based on the contents of the contextualized content cache 430. The contextualized content cache 430 refers to an amount of memory that stores lists of content determined to be relevant based on the primary program. For example, at T7 of FIG. 2D, the contextualized content cache 430 may refer to other baseball games and/or other teams in the same league as the baseball game playing in the region 216. The content adapter circuitry 420 then uses one or more of the user profile circuitry 416 and advertisement manager circuitry 418 to determine which two of the baseball games in the contextualized content cache 430 should be displayed in the region 218 (adjacent to the statistics graphic for the primary program). The contextualized content cache 430 may be implemented by any type of volatile or non-volatile memory.

The carousel manager circuitry 406 populates region 218 of the visual interface based on the primary program chosen by the tab manager circuitry 404. Accordingly, recommendations in the region 218 reflect the specific metadata of the primary program (genre, actors, run time, etc.) as opposed to the more general metadata that may describe the corresponding tab. For example, at T5 in FIG. 2C, the carousel in region 218 contains morning commentary shows because the primary program in region 216 is a morning news report. If the carousel manager circuitry 406 instead populated the region 218 based exclusively on the selected tab, the carousel is less likely to contain morning commentary shows because the term “morning” may not be used to generally describe a local news channel. Accordingly, the teachings of this disclosure enable dual-layer recommendations in which tabs/primary programs form a first layer of recommendations and auxiliary media forms a second layer of recommendations based on the first layer.

In general, programmable circuitry 301 executing the application 108A may perform operations based on the identity of one or more users that are logged-in and/or watching media on a connected display. A user may lack the necessary credentials to access media from one or more of the content providers 114 for any number of reasons, including but not limited to geographic location, subscription levels, parental controls, etc.

The authorization manager circuitry 408 confirms the user is authorized to view the primary programs that correspond to the selected tabs. In some examples, the authorization manager circuitry 408 is instantiated by programmable circuitry executing authorization management instructions and/or configured to perform operations such as those represented by the flowchart(s) of FIG. 5-10.

To determine whether a given user is permitted to watch a given piece of media, the authorization manager circuitry 408 applies user specific filters based on data in the user privilege cache 424. For example, the user privilege cache 424 may indicate a first user is allowed to watch television and movies rated R, while a second user is only allowed to watch television and movies rated PG-13. In another example, the user privilege cache 424 indicates that a third user located in the United States is be permitted to watch a show while a fourth user located in the United Kingdom is prevented from watching the same show (due, for example, to network restrictions imposed by the content providers 114).

The user privilege cache 424 may also store cryptographic keys for various trusted devices, thereby enabling the authorization manager circuitry 408 to identify which devices requests for media fail to satisfy an encryption/decryption algorithm. Such failure may be realized as an incorrect checksum, an improper public key, or the presence of any other data structure that indicates the requesting device is falsifying its identity. The authorization manager circuitry 408 may refrain from responding to any request for media that fails to satisfy a corresponding encryption/decryption algorithm.

The schedule cache 422 contains portions of pre-programmed schedules that correspond to the linear broadcasts of the content providers 114. For example, the schedule cache 422 may contain information describing which programs will air on a given broadcast and when the programs are scheduled to air. In some examples, data stored in the schedule cache 422 may be referred to as a program guide. In addition to applying filters based on data stored in the user privilege cache 424, the authorization manager circuitry 408 may only authorize primary programs that are currently airing based on the schedule cache. By doing so, the authorization manager circuitry 408 prevents the client device 102A from requesting a primary program that is not, at the time of the request, ready for presentation in region 216 of the display.

Advantageously, when the visual interface is first opened, the authorization manager circuitry 408 reduces lag times by performing operations to authorize all primary programs identified by the selected tab (rather than only authorizing primary programs when the corresponding tab is selected). Furthermore, the authorization manager circuitry 408 stores authorization results in the credential cache 410 so that, if the user re-selects a previously watched channel, the application manager 112 does not need to re-authorize the channel.

While a manner of implementing the client device 102A, the application 108A, and the application manager 112 of FIG. 1 are illustrated in FIGS. 3 and 4, one or more of the elements, processes, and/or devices illustrated in FIGS. 3 and 4 may be combined, divided, re-arranged, omitted, eliminated, and/or implemented in any other way. Further, the network interface circuitry 302, the media manager circuitry 304, the initialization manager circuitry 306, the user interface circuitry 308, the credential manager circuitry 310, the display interface circuitry 312, the API gateway circuitry 402, the tab personalization circuitry 404, the carousel manager circuitry 406, the authorization manager circuitry 408, the recommendation adapter circuitry 414, the user profile circuitry 416, the advertisement manager circuitry 418, the content adapter circuitry 420, the recommendation engine circuitry 426, and/or, more generally, the client device 102A, the application 108A, and the application manager 112 of FIGS. 3 and 4 may be implemented by hardware alone or by hardware in combination with software and/or firmware. Thus, for example, any of the network interface circuitry 302, the media manager circuitry 304, the initialization manager circuitry 306, the user interface circuitry 308, the credential manager circuitry 310, the display interface circuitry 312, the API gateway circuitry 402, the tab personalization circuitry 404, the carousel manager circuitry 406, the authorization manager circuitry 408, the recommendation adapter circuitry 414, the user profile circuitry 416, the advertisement manager circuitry 418, the content adapter circuitry 420, the recommendation engine circuitry 426, and/or, more generally, the client device 102A, the application 108A, and the application manager 112 of FIGS. 3 and 4, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the client device 102A, the application 108A, and the application manager 112 of FIGS. 3 and 4 may include one or more elements, processes, and/or devices in addition to, or instead of, those illustrated in FIGS. 3 and 4, and/or may include more than one of any or all of the illustrated elements, processes and devices.

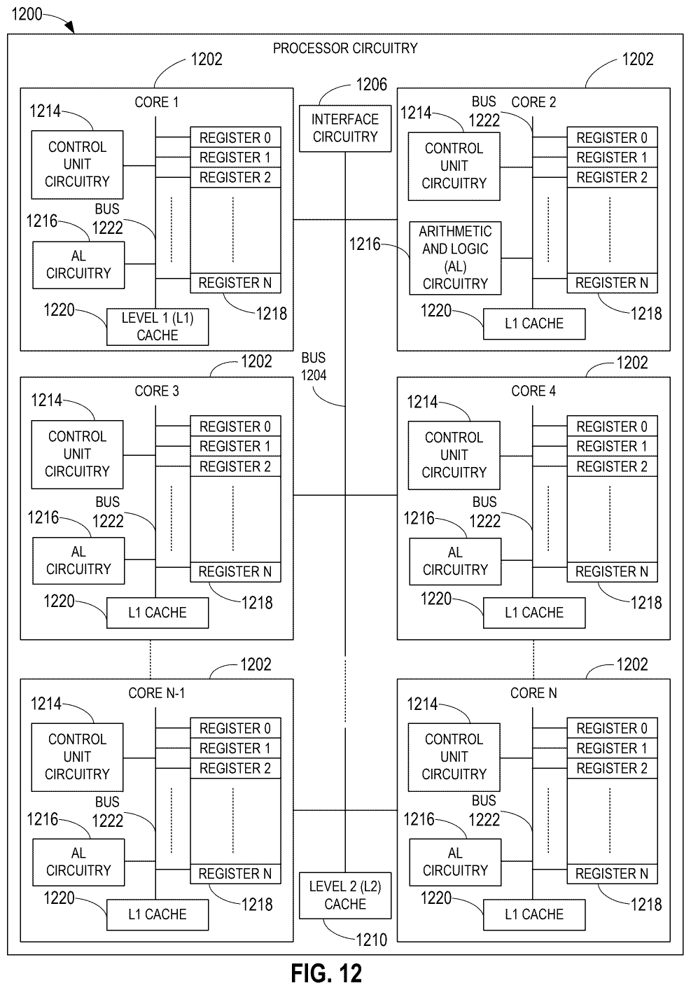

Flowchart(s) representative of example machine-readable instructions, which may be executed by programmable circuitry to implement and/or instantiate the client device 102A, the application 108A, and the application manager 112 of FIGS. 3 and 4 and/or representative of example operations which may be performed by programmable circuitry to implement and/or instantiate the client device 102A, the application 108A, and the application manager 112 of FIGS. 3 and 4, are shown in FIGS. 5-10. The machine-readable instructions may be one or more executable programs or portion(s) of one or more executable programs for execution by programmable circuitry such as the programmable circuitry 1112 shown in the example programmable circuitry platform 1100 discussed below in connection with FIG. 11 and/or may be one or more function(s) or portion(s) of functions to be performed by the example programmable circuitry (e.g., an FPGA) discussed below in connection with FIGS. 12 and/or 13. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 5-10, many other methods of implementing the client device 102A, the application 108A, and the application manager 112 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 5-10 may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine-readable medium, and/or non-transitory machine-readable storage medium are expressly defined to include any type of computer readable storage device and/or storage disk and to exclude propagating signals and to exclude transmission media. Examples of such non-transitory computer readable medium, non-transitory computer readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine-readable instructions, etc., and/or manufactured to execute computer-readable instructions, machine-readable instructions, etc.

FIG. 5 is a flowchart representative of example machine-readable instructions and/or example operations 500 that may be executed, instantiated, and/or performed by programmable circuitry to implement the visual interface of FIGS. 2A-2D. Blocks in the flowchart of FIG. 5 are separated into two columns labelled with reference numerals from FIG. 2. Blocks listed in the column with label ‘108A’ refer to machine-readable instructions that include the application 108A of FIG. 3. Accordingly, blocks in the column label ‘108A’ may be implemented by the programmable circuitry 301 executing the application 108, and/or by other components within the client device 102A of FIG. 1. Similarly, blocks listed in the column with label ‘112’ are implemented by components in the application manager 112 of FIG. 4. While the flowchart of FIG. 5 and other examples described herein refer to the client device 102A and the playback device 104A, the teachings of this disclosure may apply to the client device 102B and/or smart device 106, thereby causing the presentation of audio/visual data on any of the playback devices 104 or the smart device 106 of FIG. 1.

The machine-readable instructions and/or the operations 500 begin when the display interface circuitry 312 within the client device 102A causes media (e.g., a video) to play in full screen on the playback device 104A. (Block 502). The media may be any video that the application manager 112 determined: a) a corresponding user is permitted to watch, and b) is currently airing on a linear broadcast.

The user interface circuitry 308 detects that a user has selected the visual interface. (Block 504). The user may select the visual interface by selecting one or more buttons on a remote, by providing a voice command, etc. The user interface circuitry 308 informs the initialization manager circuitry 306 that the visual interface was selected. In turn, the initialization manager circuitry 306 causes the media manager circuitry 304 to generate an API request for tabs and transmit the request at block 504.

In response to the selection of the visual interface, the initialization manager circuitry 306 causes the media manager circuitry 304 to request data used to populate visual interface. (Block 505). The request of block 505 may include a request for an ordered list of visual icons to present on the tabs of region 214, a request for a set of primary programs that correspond to the tabs, and/or a request for auxiliary media corresponding to the primary program of the selected tab. The media manager circuitry 304 may implement block 505 by generating one or more API requests that are transmitted to the application manager 112 via the network interface circuitry 302.

Within the application manager 112, the tab manager circuitry 404 forms a list of tabs. (Block 506). Forming a list of tabs includes both: a) identifying content providers (and visual icons) that correspond to the tabs, and b) determining an ordered sequence of the tabs. The tab manager circuitry 404 identifies the list based on instructions from the API gateway circuitry 402. Block 506 is discussed further in connection with FIG. 6. In some examples, the list of tabs may be referred to as a set, a group, a collection, etc.

The tab manager circuitry 404 selects a tab from the list. (Block 508). The tab manager circuitry 404 then determines a primary program based on the tab. (Block 510). To determine a primary program, the tab manager circuitry 404 selects one program currently airing on a linear broadcast that corresponds to the selected tab. The tab manager circuitry 404 may further select the primary program based on watch history and/or user profiles.

The tab manager circuitry 404 determines whether all tabs have been selected. (Block 512). If there is a tab from the list of block 506 that remains unselected (Block 512: No), control returns to block 508 where the tab manager circuitry 404 selects a tab that has not been yet selected.

If all tabs from block 506 have been selected (Block 512: Yes), the authorization manager circuitry 408 bulk authenticates the primary programs. (Block 514). By authenticating the entire set of selected primary programs after identification, the application manager 112 removes the need for programmable circuitry 301 executing the application 108A to request authorization when a tab is selected. Accordingly, the application manager 112 reduces the delay time for primary programs to load, thereby increasing user experience. Block 514 is discussed further in connection with FIG. 7.

The API gateway circuitry 402 transmits a manifest file to the client device 102A. (Block 516). The manifest file refers to data that may be used by programmable circuitry 301 executing the application 108A. That is, programmable circuitry 301 executing the application 108A may request using the manifest file and from one of the content providers 114 accessible to the client device 102A, a particular portion of a linear broadcast. In some examples, the manifest file may be implemented with data structures describing timestamps and uniform resource links (URLs) that correspond to the timestamps. More generally, the manifest file describes which primary programs correspond to the ordered list of tabs and where programmable circuitry 301 executing the application 108A can request media stream portions of the primary programs.

In the example of FIG. 5, the manifest file of block 516 also includes a description of the tabs (e.g., data that informs the client device 102A which visual icons to display in region 214 and what order to display the visual icons in). In other examples, the application manager 112 provides a description of the tabs to the client device 102A in a separate transmission from the manifest file.

When executing the application 108A, programmable circuitry 301 instantiates the media manager circuitry 304 to request and receive, using the manifest file, a threshold amount of media stream data for the first primary program. (Block 518). In this example, the first primary program of block 518 refers to the primary program that corresponds to the leftmost tab in the ordered list of block 506. To play a media stream portion (e.g., an amount of video data) between time A and time B, the media manager circuitry 304 may use the manifest file to identify the URL that corresponds to the time segment [A, B]. The media manager circuitry 304 then sends a request over the network 110 using the URL, thereby causing the appropriate content provider (e.g., content provider 114A) to transmit the appropriate media stream portion. In some examples, the media manager circuitry 304 requests the media stream portion as a Hypertext Transfer Protocol (HTTP) request.

The media manager circuitry 304 requests and receives a threshold amount of media stream data at block 518 sufficient to begin presenting the first primary program in the region 216 of the visual interface. The quantity of media stream data obtained at block 518 may change based on factors including but not limited to the bitrate of the media stream, the resolution of the media stream, etc. In some examples, the initialization manager circuitry 306 causes the display interface circuitry 312 to begin playing a primary program once data is present to display a threshold amount of time (e.g., once n seconds of the media stream have been loaded, where n is any positive number). Similarly, the number of requests made by the media manager circuitry 304 at block 518 may change based on the amount of media stream data used to begin playing the first program and the amount of media stream data received per URL request.

Within the application manager 112, the carousel manager circuitry 406 identifies and transmits auxiliary media to be displayed while the first tab in the ordered list of tabs is selected. (Block 520). In the example of FIGS. 2A-2D, the first tab is displayed as the leftmost tab in region 214 of the visual interface. The carousel manager circuitry 406 determines the auxiliary media based on the primary program chosen at block 510 while the first tab is selected. Accordingly, the carousel manager circuitry 406 may implement block 520 at any time after the primary programs have been determined (Block 512: Yes). In some examples, the carousel manager circuitry 406 identifies and transmits auxiliary media in parallel with the execution of blocks 514, 516, and/or 518.

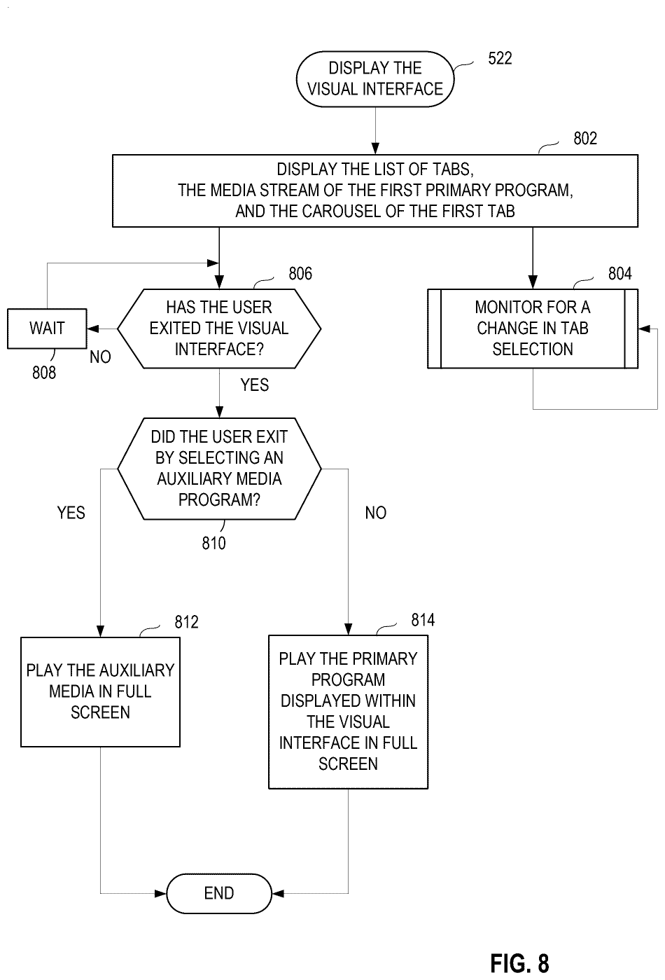

After receiving the threshold amount of media stream data for the first primary program from one of the content providers 114 (block 518) and after receiving the corresponding auxiliary media from the application manager 112 (block 520), the initialization manager circuitry 306 within the client device 102A causes the display interface circuitry 312 to display the visual interface on the playback device 104A. Execution of block 522 is discussed further in connection with FIG. 8. The example machine-readable instructions and/or operations 500 end after block 522.

FIG. 6 is a flowchart representative of example machine-readable instructions and/or example operations that may be executed, instantiated, and/or performed by the application manager of FIG. 1 to form a list of tabs as discussed in connection with FIG. 5. In particular, the flowchart of FIG. 6 is an example implementation of block 506 of FIG. 5.

Execution of block 506 begins when the API gateway circuitry 402 receives the API request for tabs from block 505. (Block 602). The API gateway circuitry 402 then interprets the request at block 602 to determine instructions for other components of the application manager 112. In some examples, the API gateway circuitry 402 also decrypts, unpackages, and/or reformats data from the API request at block 602.

The interpretation of the API request at block 602 causes the tab manager circuitry 404 to determine a set of tabs based on watch history. (Block 604). For example, the tab manager circuitry 404 may implement block 604 by using the watch history cache 412 to identify the n programs that were watched most recently, where n is any positive integer. The tab manager circuitry 404 then determines at block 604 that the content providers 114 who broadcasted the n programs will be represented as visual icons on tabs in the visual interface.

In examples described herein, the tab manager circuitry 404 determines some but not all the tabs on the visual interface at block 604. Accordingly, the tab manager circuitry 404 also determines a set of tabs based on a user profile. (Block 606). To do so, the user profile circuitry 416, recommendation adapter circuitry 414, and/or the recommendation engine circuitry 426 may exchange data to recommend content providers based on user profile data.

The tab manager circuitry 404 causes the API gateway circuitry 402 to provide both sets of tabs (from blocks 604 and 606) to the client device 102A as an ordered list. When forming the ordered list, the tab manager circuitry 404 may determine the position/index of a tab based on the relative relevance of the sets. For example, in FIGS. 2A-2D, the tabs based on watch history are placed to the left of the tabs based on a user profile to support uses cases where the user is more likely seeking a recent program to watch than a new program. In other examples, tabs based on a user profile may be valued as more relevant than tabs based on watch history. In such examples, the tab manager circuitry 404 may form the ordered list of block 608 such that tabs based on the user profile are more easily accessible within the visual interface.

At block 608, the tab manager circuitry 404 may also determine the position/index of a tab based on the relevance of a tab within its respective set. For example, in FIGS. 2A-2D, the tab representing the content provider watched most recently is positioned to the left of the tab representing the second most recent content provider. Similarly, in FIGS. 2A-2D, the tab representing the content provider with the strongest recommendation (e.g., most likely to interest the user) is positioned to the left of the tab representing the content provider with the second strongest recommendation. Control returns to block 508 of FIG. 5 after block 608.

FIG. 7 is a flowchart representative of example machine-readable instructions and/or example operations that may be executed, instantiated, and/or performed by the application manager 112 of FIG. 1 to bulk authenticate primary programs as discussed in connection with FIG. 5. In particular, the flowchart of FIG. 7 is an example implementation of block 514 of FIG. 5.

Execution of block 514 begins when the authorization manager circuitry 408 selects a primary program that corresponds to a tab. (Block 702). In examples described herein, the authorization manager circuitry 408 selects primary programs based on the ordered listing of corresponding tabs. Accordingly, between T1 and T2 of FIG. 2A, the authorization manager circuitry 408 selects: the program from the home improvement channel in a first iteration of block 702, the baseball game in a second iteration of block 702, the morning news show in a third iteration of block 702, etc. Advantageously, by selecting primary programs based on the ordered listing of tabs, the authorization manager circuitry 408 authorizes programs that are more likely to be played in the region 216 before programs that are less likely to pe played.

The authorization manager circuitry 408 determines if the selected primary program has already been authorized. (Block 704). The authorization manager circuitry 408 executes block 704 by checking the credential cache 410, which lists primary programs that have previously been authorized. For example, between T1 and T2 at FIG. 2A, the program from the home improvement channel is already listed in the credential cache 410 because the program was authorized earlier (e.g., before the program began to play in full screen). In such examples where the selected primary program is already authorized (Block 704: Yes), control proceeds to block 710.

The example flowchart of FIG. 7 shows that authorization is skipped (at block 706 and 708) whenever the primary program has been previously authorized (block 704: Yes). In some examples, the authorization manager circuitry 408 periodically reauthorizes primary programs to account for potential changes to user privilege data. For instance, a user may be unable to initially access a particular content provider 114A but may later gain access after upgrading a subscription model.

If the selected program has not yet been authorized (Block 704: No), the authorization manager circuitry 408 authorizes the primary program based on user privilege data. (Block 706). To do so, the authorization manager circuitry 408 may apply filters using data in the user privilege cache 424. Data in the user privilege cache indicates restrictions that apply to various users' viewing abilities. Such restrictions can be based on factors including but not limited to content rating, parent controls, subscription models, location, etc. as discussed above in connection with FIG. 4.

A given client device 102A may support to multiple user profiles. In such examples, a change in user profile at the client device 102A will cause the authorization manager circuitry 408 to confirm the new user is authorized to watch media. The confirmation may include a reauthorization of a program that was already authorized using privilege data of a previous user.

The authorization manager circuitry 408 authorizes the primary program based on a schedule of linear broadcasts. (Block 708). For example, the authorization manager circuitry 408 may only authorize primary programs that are currently airing based on data in the schedule cache 422. By doing so, the authorization manager circuitry 408 prevents the client device 102A from requesting a primary program that is not, at the time of the request, ready for presentation in region 216 of the display.

The authorization manager circuitry 408 determines whether all primary programs have been selected. (Block 710). If a primary program has not been selected (Block 710: No), control returns to block 702 where the authorization manager circuitry 408 selects a primary program that corresponds to a tab. If a primary program has been selected (Block 710: Yes), the machine-readable instructions and/or operations 500 return to block 516 of FIG. 5.

In the example of FIG. 7, the authorization manager circuitry 408 authorizes the primary programs sequentially. In some examples, the authorization manager circuitry 408 authorizes one or more of the primary programs in parallel.

FIG. 8 is a flowchart representative of example machine-readable instructions and/or example operations that may be executed, instantiated, and/or performed by the client device of FIG. 1 to display a visual interface as described in connection with FIG. 5. In particular, the flowchart of FIG. 8 is an example implementation of block 522 of FIG. 5.

Execution of block 522 begins when the initialization manager circuitry 306 causes the display interface circuitry 312 to display the list of tabs, play the media stream of the first primary program, and display the carousel of the first tab. (Block 802). The foregoing components are displayed in regions 214, 216, and 218 of the visual interface of FIGS. 2A-2D, respectively. In some examples, the visual interface includes additional components other than those shown in FIGS. 2A-2D.

The user interface circuitry 308 monitors for user inputs that indicate a different tab has been selected. (Block 804). Programmable circuitry 301 executing the application 108A may implement block 804 continuously and in parallel with blocks 806 and 808. Block 804 is discussed further in connection with FIG. 9.

In parallel with block 804, the user interface circuitry 308 also determines if the user has exited the visual interface. (Block 806). A user may use any suitable input (e.g., one or more button presses, a voice command) to exit the visual interface.

The user interface circuitry 308 determines if the user exited the visual interface by selecting an auxiliary program. (Block 810). If the user exited the visual interface by selecting an auxiliary media program (Block 810: Yes), the initialization manager circuitry 306 causes the display interface circuitry 312 to play the selected auxiliary media in full screen. (Block 812). Before doing so, the initialization manager circuitry 306 may cause the media manager circuitry 304 to request a threshold number of media portions of the auxiliary media from a content provider, as discussed above in connection with block 518 of FIG. 5. The initialization manager circuitry 306 may also cause the credential manager circuitry 310 to request authorization of the auxiliary media. Such a request may be required because the auxiliary media program was not part of the primary program authorized at block 514. The credential manager circuitry 310 may request authorization of the auxiliary media by generating an API request and transmitting the request to the application manager 112 via the network interface circuitry 302 and network 110.

Alternatively, if the user did not exit the visual interface by selecting an auxiliary media program (Block 810: No), the initialization manager circuitry 306 causes the display interface circuitry 312 to play the primary program of region 216 in full screen. (Block 814). The request of block 814 is not preceded by operations for authorization or media stream portions (like block 812 is) because the primary program is already authorized and playing—that is, the client device 102A is already tuned to the primary program at block 802. The machine-readable instructions and/or operations 500 end after block 814.

The flowchart of FIG. 8 shows that a user may exit the visual interface of FIGS. 2A-2D without explicitly selecting the primary program in region 216. Moreover, a user may exit the visual interface without making any type of selection. When executing the application 108A in such examples, programmable circuitry 301 causes the display interface circuitry 312 to play the primary program of region 216 in full screen because it has already been selected, authorized, and loaded. Accordingly, programmable circuitry 301 executing the application 108A improves the user experience over other visual interfaces that wait for a particular program to be selected before initializing the program.

FIG. 9 is a flowchart representative of example machine-readable instructions and/or example operations that may be executed, instantiated, and/or performed by the client device of FIG. 1 to monitor for pin changes as described in connection with FIG. 8. In particular, the flowchart of FIG. 9 is an example implementation of block 804 of FIG. 8.

Execution of block 804 begins when the user interface circuitry 308 determines if the user has selected a new tab. (Block 902). If the user has not selected a new tab (Block 902: No), programmable circuitry 301 executing the application 108A waits for a period (Block 904) before control returns to block 902.

If the user has selected a new tab (Block 902: Yes), the initialization manager circuitry 306 causes the media manager circuitry 304 to request and receive auxiliary media based on the new tab. (Block 906). For example, the media manager circuitry 304 may transmit an API call to the application manager 112 (via the network interface circuitry 302 and the network 110). The API call informs the application manager 112 which tab has been newly selected and requests corresponding auxiliary media. In some examples, the media manager circuitry 304 transmits more than one API call at block 906. In turn, the media manager circuitry 304 receives an API response from the application manager 112 that indicates what material should be presented in the carousel of region 218.

The initialization manager circuitry 306 causes the media manager circuitry 304 to request, based on a tab cache, media stream portions of the primary program for the new tab. (Block 908). The initialization manager circuitry 306 locally determines the primary program for the new tab by reviewing the manifest file that was transmitted at block 514 of FIG. 5.

After identifying the primary program, the media manager circuitry 304 checks the memory 314 at block 908 to determine whether there are valid corresponding media stream portions in one of the tab caches 316. If there are valid corresponding media stream portions in a tab cache 316A, the media manager circuitry 304 does not re-request said media stream portions from the appropriate content provider 114A. Rather, the media manager circuitry 304 counts the valid corresponding media stream portions in the tab cache 316A towards the threshold amount of data required to play the program in the region 216.

In response to the request of block 908, the network interface circuitry 302 receives a portion of the media stream from the content provider 114A. (Block 910). The media manager circuitry 304 then determines whether a threshold amount of media stream data has been received. (Block 912). In some examples, the threshold amount of media stream data corresponds to the ability for the client device 102A to play n seconds of a primary program (where n is any positive number) without additional loading or buffering.

If the newly received media stream portion at block 910 does not result in the client device 102A receiving the threshold amount of media stream data (Block 912: No), programmable circuitry 301 executing the application 108A waits a period (Block 914) until control returns to block 910 and another portion of the media stream is received from the appropriate content provider 114.

If the newly received media stream portion at block 910 does result in the client device 102A reaching the threshold amount of media stream data (Block 912: Yes), programmable circuitry 301 executing the application 108A causes the display interface circuitry 312 to update the visual interface to play the primary program and display the carousel of the new tab. (Block 916). Playing the primary program at block 916 refers to the presentation of both audio and visual data received in multiple media stream portions at block 910.

In parallel with the loop of blocks 910-914 and after block 916, the user interface circuitry 308 determines whether the user has selected another new tab. (Block 918). If the user has not selected another new tab (Block 918: No), programmable circuitry 301 executing the application 108A waits for a period (Block 920) before control returns to block 918.

If the user has selected a new tab (Block 920: Yes), the initialization manager circuitry 306 may cause the storage of unpresented media stream portions in a tab cache. (Block 922). Programmable circuitry 301 executing the application 108A implements the loop of blocks 918 and 920 in parallel with the loop of blocks 910-914. Accordingly, if the user selects a new tab before enough media stream portions are received to play the primary program of the previous tab, the initialization manager circuitry 306 can store the received media stream portions of the previous tab at 902, thereby enabling the potential re-usage of the stream portions if the previous tab is re-selected.

In some examples, the media manager circuitry 304 invalidates media stream portions in the tab caches 316 after a threshold amount of time. Invalidation may occur because the obtained media stream portions have fallen out of synchronization with the status of the program playing in real time on the linear broadcast. In such examples, the media manager circuitry 304 may discard and/or rewrite invalid media stream portions in the memory 314.

As an example, at T4 of FIG. T3, the user selected a new tab (the local news channel) before the client device 102A had received enough media stream portions to play the primary program of the previous tab (the baseball team). Accordingly, programmable circuitry 301 executing the application 108A causes the implementation of block 922, and the initialization manager circuitry 306 stores the media stream portions of the baseball game that were received between T3 and T4. The storage of the media portions are then re-used when the baseball team tab is re-selected, thereby reducing the time between re-selecting the baseball team tab (at T6 of FIG. 2C) and playing the baseball game in the region 216 (at T7 of FIG. 2D).

Following block 922, control returns to block 906, where the initialization manager circuitry 306 causes the media manager circuitry 304 to request and receive auxiliary media based on the new tab. The flowchart of FIG. 9 does not include a stop or return condition. Rather, programmable circuitry 301 executing the application 108A implements the flowchart of FIG. 9 (e.g., block 804) in parallel with blocks 806-814 of FIG. 8, which does contain a stop condition.

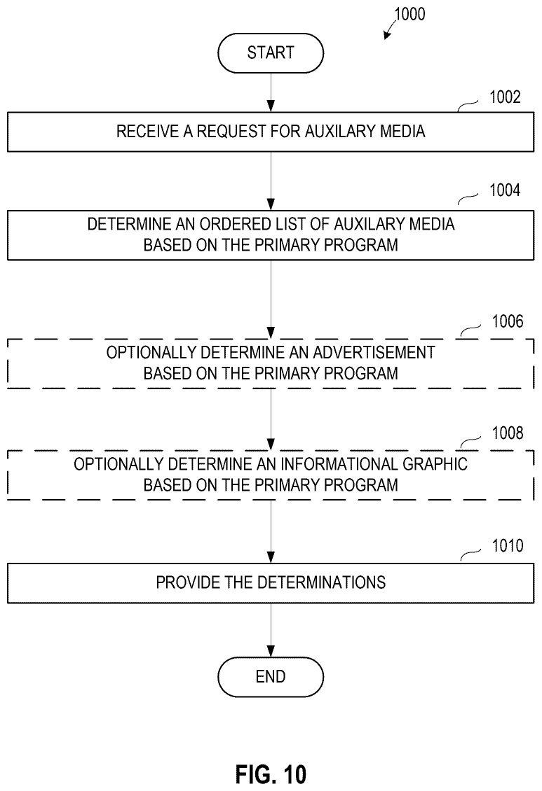

FIG. 10 is a flowchart representative of example machine-readable instructions and/or example operations that may be executed, instantiated, and/or performed by the application manager 112 of FIG. 1 to provide a carousel of auxiliary media. The example machine-readable instructions and/or operations 1000 begin when the API gateway circuitry 402 receives a request for auxiliary media. (Block 1002). The request may be transmitted by an external device. For example, at block 906 in FIG. 9, the programmable circuitry 301 executing the application 108A causes the network interface circuitry 302 to transmit a request for auxiliary media. The request may alternatively be transmitted by an internal component of the application manager 112. For example, the implementation of block 520 in FIG. 5 may be initiated by the tab management circuitry 404 sending a request to the API gateway circuitry 402 for auxiliary media for the first tab.

The API gateway circuitry 402 causes the carousel manager circuitry 406 to determine an ordered list of auxiliary media based on the primary program currently playing in the region 216 of the visual interface. (Block 1004). The carousel manager circuitry 406 may determine auxiliary media based on the primary program, user profiles, and/or external recommendations, as discussed above in connection with FIG. 4. Like the tabs in region 214, the carousel manager circuitry 406 determines an order for the selected auxiliary media in region 218 based on relevance to the user. In the examples described herein, auxiliary media that is more relevant to the user may be positioned further to the left within the region 218 than auxiliary media that is less relevant to a user.

The carousel manager circuitry 406 optionally determines an advertisement based on the primary program currently playing in the region. (Block 1006). In some examples, the carousel manager circuitry 406 implements block 1006 by editing the set of auxiliary media (e.g., adding media from the list, removing media from the list, and/or changing the order of the list). In some examples, the carousel manager circuitry 406 does not execute block 1006 and does not provide an advertisement it the carousel of region 218.

The carousel manager circuitry 406 optionally determines an informational graphic based on the primary program. (Block 1008). For example, in view 211 of FIG. 2D, the scorecard with real-time game statistics is not a selectable media poster that corresponds to a different linear broadcast. Rather, the scorecard is included in the region 218 at T7 due to the relevance of the information to the baseball game playing in region 216. The carousel manager circuitry 406 may determine the information for a graphic at block 1008 from any location. For example, the real-time statistics in view 211 of FIG. 2D may be provided by a corresponding content provider 114, a different trusted source on the Internet, etc. In some examples, the carousel manager circuitry 406 does not execute block 1008 and does not provide an informational graphic in the carousel of region 218.

The carousel manager circuitry 406 causes the API gateway circuitry 402 to provide the preceding determinations to the client device 102A. (Block 1010). The preceding determinations include the ordered list from auxiliary media of block 1004, edits to the ordered list if block 1006 is executed, and information graphics if block 1008 is executed. The machine-readable instructions and/or operations 1000 end after block 1010.

FIG. 11 is a block diagram of a programmable circuitry platform 1100 structured to execute and/or instantiate the example machine-readable instructions and/or the example operations of FIGS. 5-10 to implement the client device 102A, client device 102B, smart device 106, and/or the application manager 112 of FIGS. 3 and 4. The programmable circuitry platform 1100 can be, for example, a server, a personal computer, a workstation, a self-learning machine (e.g., a neural network), a mobile device (e.g., a cell phone, a smart phone, a tablet such as an iPad™), an Internet appliance, a DVD player, a CD player, a digital video recorder, a Blu-ray player, a gaming console, a set top box, a headset (e.g., an augmented reality (AR) headset, a virtual reality (VR) headset, etc.) or other wearable device, or any other type of computing and/or electronic device.

The programmable circuitry platform 1100 of the illustrated example includes programmable circuitry 1112. The programmable circuitry 1112 of the illustrated example is hardware. For example, the programmable circuitry 1112 can be implemented by one or more integrated circuits, logic circuits, FPGAs, microprocessors, CPUs, GPUs, DSPs, and/or microcontrollers from any desired family or manufacturer. The programmable circuitry 1112 may be implemented by one or more semiconductor based (e.g., silicon based) devices. In this example, the programmable circuitry 1112 implements the media manager circuitry 304, the initialization manager circuitry 306, the credential manager circuitry 310, the API gateway circuitry 402, the tab personalization circuitry 404, the carousel manager circuitry 406, the authorization manager circuitry 408, the recommendation adapter circuitry 414, the user profile circuitry 416, the advertisement manager circuitry 418, the content adapter circuitry 420, the recommendation engine circuitry 426, and/or, more generally, the programmable circuitry 301 and/or the application manager 112.

The programmable circuitry 1112 of the illustrated example includes a local memory 1113 (e.g., a cache, registers, etc.). The programmable circuitry 1112 of the illustrated example is in communication with main memory 1114, 1116, which includes a volatile memory 1114 and a non-volatile memory 1116, by a bus 1118. The volatile memory 1114 may be implemented by Synchronous Dynamic Random Access Memory (SDRAM), Dynamic Random Access Memory (DRAM), and/or any other type of RAM device. The non-volatile memory 1116 may be implemented by flash memory and/or any other desired type of memory device. Access to the main memory 1114, 1116 of the illustrated example is controlled by a memory controller 1117. In some examples, the memory controller 1117 may be implemented by one or more integrated circuits, logic circuits, microcontrollers from any desired family or manufacturer, or any other type of circuitry to manage the flow of data going to and from the main memory 1114, 1116. In this example, the main memory 1114, 1116 implements the memory 314 (including the tab caches 316), the credential cache 410, the watch history cache 412, the schedule cache 422, and the user privilege cache 424.

The programmable circuitry platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In this example, the interface circuitry 1120 implements the network interface circuitry 302, the user interface circuitry 308, and the display interface circuitry 312.

In the illustrated example, one or more input devices 1122 are connected to the interface circuitry 1120. The input device(s) 1122 permit(s) a user (e.g., a human user, a machine user, etc.) to enter data and/or commands into the programmable circuitry 1112. The input device(s) 1122 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1124 are also connected to the interface circuitry 1120 of the illustrated example. The output device(s) 1124 can be implemented, for example, by playback devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1100 of the illustrated example also includes one or more mass storage discs or devices 1128 to store firmware, software, and/or data. Examples of such mass storage discs or devices 1128 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 1132, which include the application 108A and which may be implemented by the machine-readable instructions of FIGS. 5-10, may be stored in the local memory 1113, the mass storage device 1128, in the volatile memory 1114, in the non-volatile memory 1116, and/or on at least one non-transitory computer readable storage medium such as a CD or DVD which may be removable.

FIG. 12 is a block diagram of an implementation of the programmable circuitry 1112 of FIG. 11. In this example, the programmable circuitry 1112 of FIG. 11 is implemented by a microprocessor 1200. For example, the microprocessor 1200 may be a general-purpose microprocessor (e.g., general-purpose microprocessor circuitry). The microprocessor 1200 executes some or all of the machine-readable instructions of the flowcharts of FIGS. 5-10 to effectively instantiate the circuitry of FIG. 2 as logic circuits to perform operations corresponding to those machine-readable instructions. In some such examples, the circuitry of FIGS. 3 and 4 is instantiated by the hardware circuits of the microprocessor 1200 in combination with the machine-readable instructions. For example, the microprocessor 1200 may be implemented by multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine-readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine-readable instructions and/or operations represented by the flowcharts of FIGS. 5-10.

The cores 1202 may communicate by a first example bus 1204. In some examples, the first bus 1204 may be implemented by a communication bus to effectuate communication associated with one(s) of the cores 1202. For example, the first bus 1204 may be implemented by at least one of an Inter-Integrated Circuit (I2C) bus, a Serial Peripheral Interface (SPI) bus, a PCI bus, or a PCIe bus. Additionally or alternatively, the first bus 1204 may be implemented by any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2 cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of registers 1218, the local memory 1220, and a second example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer based operations. In other examples, the AL circuitry 1216 also performs floating-point operations. In yet other examples, the AL circuitry 1216 may include first AL circuitry that performs integer-based operations and second AL circuitry that performs floating-point operations. In some examples, the AL circuitry 1216 may be referred to as an Arithmetic Logic Unit (ALU).

The registers 1218 are semiconductor-based structures to store data and/or instructions such as results of one or more of the operations performed by the AL circuitry 1216 of the corresponding core 1202. For example, the registers 1218 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1218 may be arranged in a bank as shown in FIG. 12. Alternatively, the registers 1218 may be organized in any other arrangement, format, or structure, such as by being distributed throughout the core 1202 to shorten access time. The second bus 1222 may be implemented by at least one of an I2C bus, a SPI bus, a PCI bus, or a PCIe bus.

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages.

The microprocessor 1200 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1200, in the same chip package as the microprocessor 1200 and/or in one or more separate packages from the microprocessor 1200.

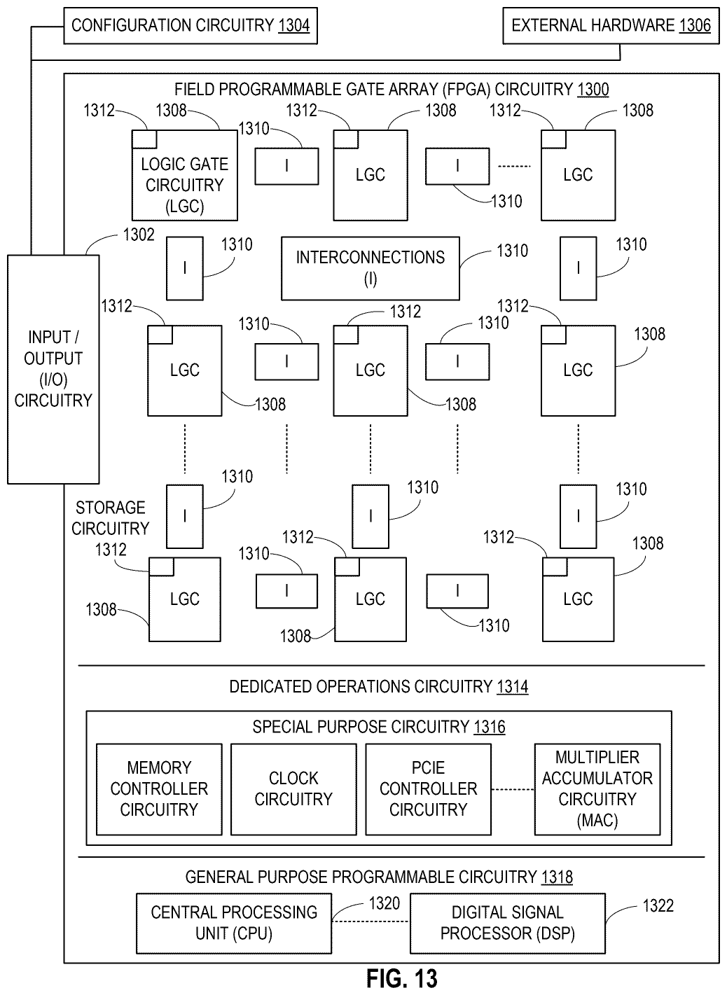

FIG. 13 is a block diagram of another example implementation of the programmable circuitry 1112 of FIG. 11. In this example, the programmable circuitry 1112 is implemented by FPGA circuitry 1300. For example, the FPGA circuitry 1300 may be implemented by an FPGA. The FPGA circuitry 1300 can be used, for example, to perform operations that could otherwise be performed by the example microprocessor 1200 of FIG. 12 executing corresponding machine-readable instructions. However, once configured, the FPGA circuitry 1300 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1200 of FIG. 12 described above (which is a general purpose device that may be programmed to execute some or all of the machine-readable instructions represented by the flowchart(s) of FIGS. 5-10 but whose interconnections and logic circuitry are fixed once fabricated), the FPGA circuitry 1300 of the example of FIG. 13 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 5-10. In particular, the FPGA circuitry 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 5-10. As such, the FPGA circuitry 1300 may be configured and/or structured to effectively instantiate some or all of the operations/functions corresponding to the machine-readable instructions of the flowchart(s) of FIGS. 5-10 as dedicated logic circuits to perform the operations/functions corresponding to those software instructions in a dedicated manner analogous to an ASIC. Therefore, the FPGA circuitry 1300 may perform the operations/functions corresponding to the some or all of the machine-readable instructions of FIGS. 5-10 faster than the general-purpose microprocessor can execute the same.

In the example of FIG. 13, the FPGA circuitry 1300 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

The FPGA circuitry 1300 of FIG. 13, includes example input/output (I/O) circuitry 1302 to obtain and/or output data to/from example configuration circuitry 1304 and/or external hardware 1306. For example, the configuration circuitry 1304 may be implemented by interface circuitry that may obtain a binary file, which may be implemented by a bit stream, data, and/or machine-readable instructions, to configure the FPGA circuitry 1300, or portion(s) thereof. In some such examples, the configuration circuitry 1304 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1306 may be implemented by external hardware circuitry. For example, the external hardware 1306 may be implemented by the microprocessor 1200 of FIG. 12.

The FPGA circuitry 1300 also includes an array of example logic gate circuitry 1308, a plurality of example configurable interconnections 1310, and example storage circuitry 1312. The logic gate circuitry 1308 and the configurable interconnections 1310 are configurable to instantiate one or more operations/functions that may correspond to at least some of the machine-readable instructions of FIGS. 5-10 and/or other desired operations. The logic gate circuitry 1308 shown in FIG. 13 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations/functions. The logic gate circuitry 1308 may include other electrical structures such as look-up tables (LUTs), registers (e.g., flip-flops or latches), multiplexers, etc.

The configurable interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example dedicated operations circuitry 1314. In this example, the dedicated operations circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as a CPU 1320 and/or a DSP 1322. Other general purpose programmable circuitry 1318 may additionally or alternatively be present such as a GPU, an XPU, etc., that can be programmed to perform other operations.

Although FIGS. 12 and 13 illustrate two example implementations of the programmable circuitry 1112 of FIG. 11, many other approaches are contemplated. For example, FPGA circuitry may include an on-board CPU, such as one or more of the example CPU 1320 of FIG. 12. Therefore, the programmable circuitry 1112 of FIG. 11 may additionally be implemented by combining at least the example microprocessor 1200 of FIG. 12 and the example FPGA circuitry 1300 of FIG. 13. In some such hybrid examples, one or more cores 1202 of FIG. 12 may execute a first portion of the machine-readable instructions represented by the flowchart(s) of FIGS. 5-10 to perform first operation(s)/function(s), the FPGA circuitry 1300 of FIG. 13 may be configured and/or structured to perform second operation(s)/function(s) corresponding to a second portion of the machine-readable instructions represented by the flowcharts of FIG. 5-10, and/or an ASIC may be configured and/or structured to perform third operation(s)/function(s) corresponding to a third portion of the machine-readable instructions represented by the flowcharts of FIGS. 5-10.

It should be understood that some or all of the circuitry of FIGS. 3 and 4 may, thus, be instantiated at the same or different times. For example, same and/or different portion(s) of the microprocessor 1200 of FIG. 12 may be programmed to execute portion(s) of machine-readable instructions at the same and/or different times. In some examples, same and/or different portion(s) of the FPGA circuitry 1300 of FIG. 13 may be configured and/or structured to perform operations/functions corresponding to portion(s) of machine-readable instructions at the same and/or different times.

In some examples, some or all of the circuitry of FIGS. 3 and 4 may be instantiated, for example, in one or more threads executing concurrently and/or in series. For example, the microprocessor 1200 of FIG. 12 may execute machine-readable instructions in one or more threads executing concurrently and/or in series. In some examples, the FPGA circuitry 1300 of FIG. 13 may be configured and/or structured to carry out operations/functions concurrently and/or in series. Moreover, in some examples, some or all of the circuitry of FIGS. 3 and 4 may be implemented within one or more virtual machines and/or containers executing on the microprocessor 1200 of FIG. 12.

In some examples, the programmable circuitry 1112 of FIG. 11 may be in one or more packages. For example, the microprocessor 1200 of FIG. 12 and/or the FPGA circuitry 1300 of FIG. 13 may be in one or more packages. In some examples, an XPU may be implemented by the programmable circuitry 1112 of FIG. 11, which may be in one or more packages. For example, the XPU may include a CPU (e.g., the microprocessor 1200 of FIG. 12, the CPU 1320 of FIG. 13, etc.) in one package, a DSP (e.g., the DSP 1322 of FIG. 13) in another package, a GPU in yet another package, and an FPGA (e.g., the FPGA circuitry 1300 of FIG. 13) in still yet another package.

A block diagram illustrating a software distribution platform 1405 to distribute software such as the example machine-readable instructions 1132 of FIG. 11 to other hardware devices (e.g., hardware devices owned and/or operated by third parties from the owner and/or operator of the software distribution platform) is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine-readable instructions 1132 of FIG. 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine-readable instructions 1132, which may correspond to the example machine-readable instructions of FIGS. 5-10, as described above. The one or more servers of the example software distribution platform 1405 are in communication with a network 1410, which may correspond to any one or more of the Internet and/or any of the networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 1132 from the software distribution platform 1405. For example, the software, which may correspond to the example machine-readable instructions of FIG. 5-10, may be downloaded to the example programmable circuitry platform 1100, which is to execute the machine-readable instructions 1132 to implement the application 108A. In some examples, one or more servers of the software distribution platform 1405 periodically offer, transmit, and/or force updates to the software (e.g., the example machine-readable instructions 1132 of FIG. 11) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that enable a visual interface for users to discover and watch media. Disclosed systems, apparatus, articles of manufacture, and methods improve the efficiency of using a computing device by determining a primary program for a set of identified tabs, by bulk authorizing the primary programs in response to the determination, and by beginning to load a primary program as soon as a corresponding tab is selected in the visual interface. As a result, the time required to load and present video data at a playback device is reduced compared to other interfaces containing media. Furthermore, a user can exit the visual interface described herein and view the primary program in full screen without an explicit selection within the interface, thereby improving user experience. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to present a visual interface are disclosed herein. Further examples and combinations thereof include the following.

Example 1 includes a system comprising programmable circuitry, a memory that stores executable instructions that, when executed or instantiated by the programmable circuitry, facilitate performance of operations including playing a first media stream in full screen, determining a user has selected a visual interface, after the user has selected the visual interface, presenting, in a first region of the visual interface, a group of tabs relevant to the user and a selection of a first tab within the group, after the user has selected the visual interface, playing, in a second region of the visual interface, the first media stream, determining the user has selected a second tab within the group, after the user has selected the second tab, playing, in the second region of the visual interface, a second media stream corresponding to the second tab, after the user has selected the second tab, determining the user has exited the visual interface without performing an additional selection, and after the user has exited the visual interface, playing the second media stream in full screen.

Example 2 includes the system of example 1, wherein the operations further include requesting, in response to the user selecting the visual interface, data to populate the visual interface, and receiving, in response to the request, a manifest file describing a set of media streams that correspond to the group of tabs.

Example 3 includes the system of example 2, wherein the user is authorized to view each media stream in the set, and the authorization of the set of media streams occurs independently of which tab is selected within the first region of the visual interface.

Example 4 includes the system of example 2, wherein to play the second media stream, the operations further include identifying, using the manifest file and in response to the user selecting a second tab within the group, a content provider that corresponds to the second media stream, and receiving a threshold amount of second media stream data from the content provider.

Example 5 includes the system of example 1, wherein the operations further include identifying the user has selected a third tab in the group, and requesting, in response to the user having selected the third tab, a threshold amount of third media stream data, the third media stream data corresponding to the third tab.

Example 6 includes the system of example 5, wherein the operations further include receiving the threshold amount of third media stream data, and playing, in the second region of the visual interface, the third media stream.

Example 7 includes the system of example 5, wherein the operations further include receiving an initial amount of third media stream data, the initial amount less than the threshold amount, determining, before receiving additional third media stream data, that the user has selected a fourth tab within the group, and storing the initial amount of third media stream data in a cache for the third tab within the memory.

Example 8 includes the system of example 7, wherein the operations further include requesting, in response to a determination the user has reselected the third tab within the group, an amount of third media stream data, the requested amount to exclude the initial amount of third media stream data stored in the cache.

Example 9 includes the system of example 1, wherein the memory includes a first cache for data used to present the first media stream, and a second cache for data used to present the second media stream.

Example 10 includes the system of example 1, wherein the operations further include presenting, after the user has selected the visual interface and in a third region of the visual interface, a set of auxiliary media corresponding to the first media stream.

Example 11 includes the system of example 1, wherein the second tab corresponds to a content provider of the second media stream, and the operations further include displaying a visual icon indicative of the content provider on the second tab.

Example 12 includes the system of example 1, wherein the first media stream is a first linear broadcast, and the second media stream is a second linear broadcast.

Example 13 includes a non-transitory machine-readable storage medium comprising instructions that, when executed or instantiated by programmable circuitry, facilitate performance of operations, comprising play a first media stream in full screen, determine a user has selected a visual interface, after the user has selected the visual interface, present, in a first region of the visual interface, a group of tabs relevant to the user and a selection of a first tab within the group, after the user has selected the visual interface, play, in a second region of the visual interface, the first media stream, determine the user has selected a second tab within the group, after the user has selected the second tab, play, in the second region of the visual interface, a second media stream corresponding to the second tab, after the user has selected the second tab, determine the user has exited the visual interface without performing an additional selection, and after user has exited the visual interface, play the second media stream in full screen.

Example 14 includes the non-transitory machine-readable storage medium of example 13, wherein the operations further include requesting, in response to the user selecting the visual interface, data to populate the visual interface, and receiving, in response to the request, a manifest file describing a set of media streams that correspond to the group of tabs.

Example 15 includes the non-transitory machine-readable storage medium of example 14, wherein the user is authorized to view each media stream in the set, and the authorization of the set of media streams occurs independently of which tab is selected within the first region of the visual interface.

Example 16 includes the non-transitory machine-readable storage medium of example 14, wherein to play the second media stream, the operations further include identifying, using a manifest file and in response to the user selecting a second tab within the group, a content provider that corresponds to the second media stream, and receiving a threshold amount of second media stream data from the content provider.

Example 17 includes the non-transitory machine-readable storage medium of example 13, wherein the operations further include identifying the user has selected a third tab in the group, and requesting, in response to the user having selected the third tab, a threshold amount of third media stream data, the third media stream corresponding to the third tab.

Example 18 includes the non-transitory machine-readable storage medium of example 17, wherein the operations further include receiving the threshold amount of third media stream data, and playing, in the second region of the visual interface, the third media stream.

Example 19 includes the non-transitory machine-readable storage medium of example 17, wherein the operations further include receiving an initial amount of third media stream data, the initial amount less than the threshold amount, determining, before receiving additional third media stream data, that the user has selected a fourth tab within the group, and storing the initial amount of third media stream data in memory.

Example 20 includes the non-transitory machine-readable storage medium of example 19, wherein the operations further include requesting, in response to a determination the user has reselected the third tab within the group, an amount of third media stream data, the requested amount to exclude the initial amount of third media stream data stored in the non-transitory machine-readable storage medium.

Example 21 includes the non-transitory machine-readable storage medium of example 13, further including a first cache for data used to present the first media stream, and a second cache for data used to present the second media stream.

Example 22 includes the non-transitory machine-readable storage medium of example 13, wherein the operations further include presenting, after the user has selected the visual interface and in a third region of the visual interface, a set of auxiliary media corresponding to the first media stream.

Example 23 includes the non-transitory machine-readable storage medium of example 13, wherein the second tab corresponds to a content provider of the second media stream, and the operations further include displaying a visual icon indicative of the content provider on the second tab.

Example 24 includes a method comprising playing a first media stream in full screen, determining a user has selected a visual interface, after the selection of the visual interface, presenting, in a first region of the visual interface, a group of tabs relevant to the user and a selection of a first tab within the group, after the selection of the visual interface, playing, in a second region of the visual interface, the first media stream, determining the user has selected a second tab within the group, after the selection of the second tab, playing, in the second region of the visual interface, a second media stream corresponding to the second tab, after the selection of the second tab, determining the user has exited the visual interface without performing an additional selection, and after exiting the visual interface, playing the second media stream in full screen.

Example 25 includes the method of example 24, further including requesting, in response to the user selecting the visual interface, data to populate the visual interface, and receiving, in response to the request, a manifest file describing a set of media streams that correspond to the group of tabs.

Example 26 includes the method of example 25, wherein the user is authorized to view each media stream in the set, and the authorization of the set of media streams occurs independently of which tab is selected within the first region of the visual interface.

Example 27 includes the method of example 25, wherein playing the second media stream further includes identifying, using the manifest file and in response to the user selecting a second tab within the group, a content provider that corresponds to the second media stream, and receiving a threshold amount of second media stream data from the content provider.

Example 28 includes the method of example 24, further including identifying the user has selected a third tab in the group, requesting, in response to the selection, a threshold amount of third media stream data, the third media stream corresponding to the third tab, receiving an initial amount of third media stream data, the initial amount less than the threshold amount, determining, before receiving additional third media stream data, that the user has selected a fourth tab within the group, and storing the initial amount of third media stream data in memory.

Example 29 includes the method of example 28, further including receiving the threshold amount of third media stream data, and playing, in the second region of the visual interface, the third media stream.

Example 30 includes the method of example 28, further including requesting, in response to a determination the user has reselected the third tab within the group, an amount of third media stream data, the requested amount to exclude the initial amount of third media stream data stored in the memory.

Example 31 includes the method of example 24, further including presenting, after the selection of the visual interface and in a third region of the visual interface, a set of auxiliary media corresponding to the first media stream.

Example 32 includes the method of example 24, wherein the second tab corresponds to a content provider of the second media stream, and the method further includes displaying a visual icon indicative of the content provider on the second tab.

Example 33 includes the method of example 24, wherein the first media stream is a first linear broadcast, and the second media stream is a second linear broadcast.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. A system comprising:
programmable circuitry;
a memory that stores executable instructions that, when executed or instantiated by the programmable circuitry, facilitate performance of operations including:
playing a first media stream in full screen;
determining a user has selected a visual interface;
after the user has selected the visual interface, presenting, in a first region of the visual interface, a group of tabs relevant to the user and a selection of a first tab within the group;
after the user has selected the visual interface, playing, in a second region of the visual interface, the first media stream;
determining the user has selected a second tab within the group;
after the user has selected the second tab, playing, in the second region of the visual interface, a second media stream corresponding to the second tab;
after the user has selected the second tab, determining the user has exited the visual interface without performing an additional selection; and
after the user has exited the visual interface, playing the second media stream in full screen.

2. The system of claim 1, wherein the operations further include:
requesting, in response to the user selecting the visual interface, data to populate the visual interface; and
receiving, in response to the request, a manifest file describing a set of media streams that correspond to the group of tabs.

3. The system of claim 2, wherein:
the user is authorized to view each media stream in the set; and
the authorization of the set of media streams occurs independently of which tab is selected within the first region of the visual interface.

4. The system of claim 2, wherein to play the second media stream, the operations further include:
identifying, using the manifest file and in response to the user selecting a second tab within the group, a content provider that corresponds to the second media stream; and
receiving a threshold amount of second media stream data from the content provider.

5. The system of claim 1, wherein the operations further include:
identifying the user has selected a third tab in the group; and
requesting, in response to the user having selected the third tab, a threshold amount of third media stream data, the third media stream data corresponding to the third tab.

6. The system of claim 5, wherein the operations further include:
receiving the threshold amount of third media stream data; and
playing, in the second region of the visual interface, the third media stream.

7. The system of claim 5, wherein the operations further include:
receiving an initial amount of third media stream data, the initial amount less than the threshold amount;
determining, before receiving additional third media stream data, that the user has selected a fourth tab within the group; and
storing the initial amount of third media stream data in a cache for the third tab within the memory.

8. The system of claim 7, wherein the operations further include requesting, in response to a determination the user has reselected the third tab within the group, an amount of third media stream data, the requested amount to exclude the initial amount of third media stream data stored in the cache.

9. The system of claim 1, wherein the memory includes:
a first cache for data used to present the first media stream; and
a second cache for data used to present the second media stream.

10. The system of claim 1, wherein the operations further include presenting, after the user has selected the visual interface and in a third region of the visual interface, a set of auxiliary media corresponding to the first media stream.

11. The system of claim 1, wherein:
the second tab corresponds to a content provider of the second media stream; and
the operations further include displaying a visual icon indicative of the content provider on the second tab.

12. The system of claim 1, wherein:
the first media stream is a first linear broadcast; and
the second media stream is a second linear broadcast.

13. A non-transitory machine-readable storage medium comprising instructions that, when executed or instantiated by programmable circuitry, facilitate performance of operations, comprising:
playing a first media stream in full screen;
determining a user has selected a visual interface;
after the user has selected the visual interface, presenting, in a first region of the visual interface, a group of tabs relevant to the user and a selection of a first tab within the group;
after the user has selected the visual interface, playing, in a second region of the visual interface, the first media stream;
determining the user has selected a second tab within the group;
after the user has selected the second tab, playing, in the second region of the visual interface, a second media stream corresponding to the second tab;
after the user has selected the second tab, determining the user has exited the visual interface without performing an additional selection; and
after user has exited the visual interface, playing the second media stream in full screen.

14. (canceled)

15. (canceled)

16. The non-transitory machine-readable storage medium of claim 13, wherein to play the second media stream, the operations further include:
identifying, using a manifest file and in response to the user selecting a second tab within the group, a content provider that corresponds to the second media stream; and
receiving a threshold amount of second media stream data from the content provider.

17. The non-transitory machine-readable storage medium of claim 13,
wherein the operations further include:
identifying the user has selected a third tab in the group; and
requesting, in response to the user having selected the third tab, a threshold amount of third media stream data, the third media stream corresponding to the third tab.

18. (canceled)

19. The non-transitory machine-readable storage medium of claim 17, wherein the operations further include:
receiving an initial amount of third media stream data, the initial amount less than the threshold amount;
determining, before receiving additional third media stream data, that the user has selected a fourth tab within the group; and
storing the initial amount of third media stream data in the non-transitory machine-readable storage medium.

20. The non-transitory machine-readable storage medium of claim 19, wherein the operations further include requesting, in response to a determination the user has reselected the third tab within the group, an amount of third media stream data, the requested amount to exclude the initial amount of third media stream data stored in the non-transitory machine-readable storage medium.

21. The non-transitory machine-readable storage medium of claim 13, further including:
a first cache for data used to present the first media stream; and
a second cache for data used to present the second media stream.

22. (canceled)

23. (canceled)

24. A method comprising:
playing a first media stream in full screen;
determining a user has selected a visual interface;
after the selection of the visual interface, presenting, in a first region of the visual interface, a group of tabs relevant to the user and a selection of a first tab within the group;
after the selection of the visual interface, playing, in a second region of the visual interface, the first media stream;
determining the user has selected a second tab within the group;
after the selection of the second tab, playing, in the second region of the visual interface, a second media stream corresponding to the second tab;
after the selection of the second tab, determining the user has exited the visual interface without performing an additional selection; and
after exiting the visual interface, playing the second media stream in full screen.

25.-27. (canceled)

28. The method of claim 24, further including:
identifying the user has selected a third tab in the group;
requesting, in response to the selection, a threshold amount of third media stream data, the third media stream corresponding to the third tab;
receiving an initial amount of third media stream data, the initial amount less than the threshold amount;
determining, before receiving additional third media stream data, that the user has selected a fourth tab within the group; and
storing the initial amount of third media stream data in memory.

29-33. (canceled)
